(19) United States
(12) Patent Application Publication
(10) Pub. No.: US 2025/0227532 A1
(43) Pub. Date: Jul. 10, 2025

(54) WIRELESS COMMUNICATION METHOD, TERMINAL DEVICE AND NETWORK DEVICE

(71) Applicant: GUANGDONG OPPO MOBILE TELECOMMUNICATIONS CORP., LTD., Dongguan (CN)

(72) Inventors: Jianfei CAO, Dongguan (CN); Wendong LIU, Dongguan (CN); Zhihua SHI, Dongguan (CN)

(73) Assignee: GUANGDONG OPPO MOBILE TELECOMMUNICATIONS CORP., LTD., Dongguan (CN)

(21) Appl. No.: 19/089,351

(22) Filed: Mar. 25, 2025

Related U.S. Application Data
(63) Continuation of application No. PCT/CN2022/123327, filed on Sep. 30, 2022.

(51) Int. Cl. H04W 24/10; H04W 8/24

(52) U.S. Cl. CPC H04W 24/10; H04W 8/24

(57) ABSTRACT

A wireless communication method, a terminal device and a network device. The method includes: a terminal device acquiring a first data set, wherein the first data set includes information of a plurality of measurement spatial filters, the plurality of measurement spatial filters belong to a measurement spatial filter set, and the measurement spatial filter set is a spatial filter set for measurement; and according to the first data set and a first model, determining target information, wherein the target information includes information of K target spatial filters, the K target spatial filters belong to a prediction spatial filter set, the prediction spatial filter set is a spatial filter set for prediction, the measurement spatial filter set is a subset of the prediction spatial filter set, and K is a positive integer.

### CROSS REFERENCE TO RELATED APPLICATIONS

This is a continuation of International Application No. PCT/CN2022/123327 filed on Sep. 30, 2022, and entitled “WIRELESS COMMUNICATION METHOD, TERMINAL DEVICE AND NETWORK DEVICE”, the disclosure of which is incorporated therein by reference in its entirety.

### TECHNICAL FIELD

Embodiments of the disclosure relate to the field of communications, and in particular to a method for wireless communication, a terminal device and a network device.

### BACKGROUND

In a new radio (NR) system, communication in a millimeter-wave frequency range has been introduced, and a corresponding beam management mechanism is also introduced, which may include uplink beam management and downlink beam management. Downlink beam management includes procedures such as downlink beam sweeping, optimal beam reporting at a terminal side, and downlink beam indication at a network side. In particular, the network device sweeps all transmitting beam directions through downlink reference signals. The terminal device may use different receiving beams to perform measurement, so that all beam pairs can be traversed

It can be seen that the terminal device needs to traverse all combinations of the transmitting beams and the receiving beams to select optimal beams, which will bring lots of overhead and delay.

### SUMMARY

In a first aspect, provided is a method for wireless communication. The method includes that a terminal device acquires a first dataset. The first dataset includes information of multiple measurement spatial filters. The multiple measurement spatial filters belong to a measurement spatial filter set. The measurement spatial filter set is a spatial filter set for measurement. The method includes that target information is determined according to the first dataset and a first model. The target information includes information of K target spatial filters. The K target spatial filters belong to a predictive spatial filter set. The predictive spatial filter set is a spatial filter set for prediction. The measurement spatial filter set is a subset of the predictive spatial filter set. K is a positive integer.

In a second aspect, provided is a method for wireless communication. The method includes that a network device acquires a second dataset. The second dataset includes information of multiple measurement spatial filters, and the multiple measurement spatial filters belong to a measurement spatial filter set. The method includes that target information is determined according to the second dataset and a second model. The target information includes information of Q target spatial filters. The Q target spatial filters belong to a predictive spatial filter set. The measurement spatial filter set is a subset of the predictive spatial filter set. Q is a positive integer.

In a third aspect, provided is a method for wireless communication. The method includes that a terminal device sends a second dataset to a network device. The second dataset is used for the network device to determine target information, the second dataset includes information of multiple measurement spatial filters. The multiple measurement spatial filters belong to a measurement spatial filter set. The target information includes information of Q target spatial filters. The Q target spatial filters belong to a predictive spatial filter set. The measurement spatial filter set is a subset of the predictive spatial filter set. Q is a positive integer.

In a fourth aspect, provided is a method for wireless communication. The method includes that a network device sends first configuration information to a terminal device. The first configuration information is configured to configure at least one predictive spatial filter set and/or at least one measurement spatial filter set, the at least one measurement spatial filter set is at least one spatial filter set used for the terminal device to perform measurement, and each of the at least one measurement spatial filter set is a subset of one of the at least one predictive spatial filter set.

In a fifth aspect, provided is a terminal device for implementing the method of the first aspect, or the third aspect or various implementations of the first aspect and the third aspect.

Specifically, the terminal device includes functional modules for implementing the method of the first aspect, or the third aspect or various implementations of the first aspect and the third aspect.

In a sixth aspect, provided is a network device for implementing the method of the second aspect, or the fourth aspect or various implementations of the second aspect and the fourth aspect.

Specifically, the network device includes functional modules for implementing the method of the second aspect, or the fourth aspect or various implementations of the second aspect and the fourth aspect.

In a seventh aspect, provided is a terminal device including a processor and a memory. The memory stores a computer program, and the processor calls and runs the computer program stored in the memory to implement the method of the first aspect, or the third aspect or various implementations of the first aspect and the third aspect.

In an eighth aspect, provided is a network device including a processor and a memory. The memory stores a computer program, and the processor calls and runs the computer program stored in the memory to implement the method of the second aspect, or the fourth aspect or various implementations of the second aspect and the fourth aspect.

In a ninth aspect, provided is a chip for implementing the method of any one of the first to fourth aspects or various implementations of the first to fourth aspects. Specifically, the chip includes a processor configured to call and run a computer program from a memory, to enable a device installed with the chip to implement the method of any one of the first to fourth aspects or various implementations of the first to fourth aspects.

In a tenth aspect, provided is a computer-readable storage medium for storing a computer program that enables a computer to implement the method of any one of the first to fourth aspects or various implementations of the first to fourth aspects.

In an eleventh aspect, provided is a computer program product including computer program instructions that enable a computer to implement the method of any one of the first to fourth aspects or various implementations of the first to fourth aspects.

In a twelfth aspect, provided is a computer program that, when running on a computer, enables the computer to implement the method of any one of the first to fourth aspects or various implementations of the first to fourth aspects.

### BRIEF DESCRIPTION OF THE DRAWINGS

FIG. 1 illustrates a schematic diagram of a communication system architecture according to embodiments of the disclosure.

FIG. 2 illustrates a schematic diagram of connections of a neuron in a neural network.

FIG. 3 illustrates a schematic structural diagram of a neural network.

FIG. 4 illustrates a schematic diagram of a Convolutional Neural Network.

FIG. 5 illustrates a schematic structural diagram of a Long Short-Term Memory (LSTM) unit.

FIG. 6 illustrates a schematic diagram of a downlink beam sweeping procedure.

FIG. 7 illustrates a schematic diagram of another downlink beam sweeping procedure.

FIG. 8 illustrates a schematic diagram of yet another downlink beam sweeping procedure.

FIG. 9 illustrates a schematic diagram of a method for wireless communication according to embodiments of the disclosure.

FIG. 10 illustrates an example diagram of a model structure and an input-output relationship of a model A according to embodiments of the disclosure.

FIG. 11 illustrates an example diagram of a model structure and an input-output relationship of a model B according to embodiments of the disclosure.

FIG. 12 illustrates an example of an input and an output of a first model according to embodiments of the disclosure.

FIG. 13 illustrates a schematic diagram of preprocessing an input of the first model according to embodiments of the disclosure.

FIG. 14 illustrates another schematic diagram of preprocessing an input of the first model according to embodiments of the disclosure.

FIG. 15 illustrates yet another schematic diagram of preprocessing an input of the first model according to embodiments of the disclosure.

FIG. 16 illustrates a schematic diagram of postprocessing an output of the first model according to embodiments of the disclosure.

FIG. 17 illustrates another schematic diagram of postprocessing an output of the first model according to embodiments of the disclosure.

FIG. 18 illustrates a schematic interaction diagram of another method for wireless communication according to embodiments of the disclosure.

FIG. 19 illustrates a schematic diagram of yet another method for wireless communication according to embodiments of the disclosure.

FIG. 20 illustrates a schematic interaction diagram of another method for wireless communication according to embodiments of the disclosure.

FIG. 21 illustrates a schematic block diagram of a terminal device according to embodiments of the disclosure.

FIG. 22 illustrates a schematic block diagram of a network device according to embodiments of the disclosure.

FIG. 23 illustrates a schematic block diagram of another terminal device according to embodiments of the disclosure.

FIG. 24 illustrates a schematic block diagram of another network device according to embodiments of the disclosure.

FIG. 25 illustrates a schematic block diagram of a communication device according to embodiments of the disclosure.

FIG. 26 illustrates a schematic block diagram of a chip according to embodiments of the disclosure.

FIG. 27 illustrates a schematic block diagram of a communication system according to embodiments of the disclosure.

### DETAILED DESCRIPTION

Technical solutions of the embodiments of the disclosure will be described below in conjunction with the drawings of the embodiments of the disclosure. Apparently, the described embodiments are some rather than all embodiments of the disclosure. All other embodiments obtained by those skilled in the art based on the embodiments of the disclosure without paying any inventive effort shall fall within the scope of protection of the disclosure.

The technical solutions of the embodiments of the disclosure may be applied to various communication systems, such as a Global System of Mobile communication (GSM) system, a Code Division Multiple Access (CDMA) system, a Wideband Code Division Multiple Access (WCDMA) system, a General Packet Radio Service (GPRS) system, a Long Term Evolution (LTE) system, an Advanced Long Term Evolution (LTE-A) system, a New Radio (RA) system, an evolved NR system, an LTE-based access to unlicensed spectrum (LTE-U) system, an NR-based access to unlicensed spectrum (NR-U) system, a Non-Terrestrial Networks (NTN) system, a Universal Mobile Telecommunication System (UMTS), a Wireless Local Area Networks (WLAN), a Wireless Fidelity (WiFi), a 5th-Generation (5G) system or other communication systems.

Generally, a traditional communication system supports a limited number of connections, and is easily achievable. However, with development of communication technologies, a mobile communication system will support not only traditional communication, but will also support for example Device to Device (D2D) communication, Machine to Machine (M2M) communication, Machine Type Communication (MTC), Vehicle to Vehicle (V2V) communication, Vehicle to everything (V2X) communication or the like. The embodiments of the disclosure may also be applied to these communication systems.

Optionally, the communication system of the embodiments of the disclosure may be applied to a carrier aggregation (CA) scenario, or may be applied to a dual connectivity (DC) scenario, or may be applied to a standalone (SA) networking scenario.

Optionally, the communication system of the embodiments of the disclosure may be applied to an unlicensed spectrum. The unlicensed spectrum may be considered as a shared spectrum. Alternatively, the communication system of the embodiments of the disclosure may be applied to a licensed spectrum. The licensed spectrum may be considered as a non-shared spectrum.

In the embodiments of the disclosure, various embodiments are described in conjunction with a network device and a terminal device. For example, the terminal device may also be referred to as user equipment (UE), an access terminal, a subscriber unit, a subscriber station, a mobile station, a remote station, a remote terminal, a mobile device, a user terminal, a terminal, a wireless communication device, a subscriber agent or a user device.

The terminal device may be a station (ST) in a WLAN, or may be a cellular phone, a cordless phone, a session initiation protocol (SIP) phone, a wireless local loop (WLL) station, a personal digital assistant (PDA) device, a hand-held device with a wireless communication function, a computing device or another processing device connected to a radio modem, vehicle-mounted device, a wearable device, a terminal device in a next generation communication system for example an NR network, a terminal device in Public Land Mobile Network (PLMN) or the like.

In embodiments of the disclosure, the terminal device may be deployed on the land, including being indoor or outdoor, hand-held, wearable or vehicle-mounted; or the terminal device may be deployed on the water, for example on a chip; or may be deployed in the air, for example on a plane, a balloon, a satellite, or the like.

In embodiments of the disclosure, the terminal device may be a mobile phone, a pad, a computer with a radio transceiving function, a virtual reality (VR) terminal device, an Augmented Reality (AR) terminal device, a radio terminal device used in industrial control, a radio terminal device used in self driving, a radio terminal device used in remote medical, a radio terminal device used in smart grid, a radio terminal device used in transportation safety, a radio terminal device used in smart city, a radio terminal device used in smart home, or the like.

As an example, but not in a limiting way, in embodiments of the disclosure, the terminal device may also be a wearable device. The wearable device may also be referred to as a wearable smart device, and is a generic name of devices that are designed and developed in an intellectualized manner based on daily wear using wearable technologies, for example glasses, gloves, watches, clothes, and shoes. A wearable device is a portable device that is directly worn on a body or integrated into the clothes or accessories of a user. A wearable device is not only a hardware device, but also realizes strong functions through support of software and through data interaction and cloud interaction. Generic wearable smart devices include devices that have plentiful functions and large sizes and can realize all or some functions without depending on a smart phone, for example a smart watch or smart glasses, and also include devices that focus on only some type of application functions and need to be used in cooperation with other devices such a smart phone, for example various smart bracelets and smart jewelries performing sign monitoring.

In embodiments of the disclosure, the network device may be a device for communication with a mobile device. The network device may be an access point (AP) in a WLAN, or a base transceiver station (BTS) in GSM or CDMA, or a NodeB (NB) in WCDMA, or an Evolutional NodeB (eNB or eNodeB) in LTE, or a relay node or access point, or a vehicle-mounted device, a wearable device and a gNB in an NR network, a network device in a future evolved PLAN network, or a network in an NTN network.

As an example, but not in a limiting way, in embodiments of the disclosure, the network device may have mobility. For example, the network device may be a mobile device. Optionally, the network device may be a satellite, or a balloon station. For example, the satellite may be low earth orbit (LEO) satellite, a medium earth orbit (MEO) satellite, a geostationary earth orbit (GEO) satellite, a high elliptical orbit (HEO) satellite or the like. Optionally, the network device may also be a base station deployed on the land, in a water area, or the like.

In the embodiments of the disclosure, the network device may provide service for a cell, and a terminal device may communicate with the network device through a transmission resource (for example, a frequency domain resource, or a frequency spectrum resource) used by the cell. The cell may be a cell corresponding to the network device (for example, a base station). The cell may belong to a macro base station, or may belong to a base station corresponding to a small cell. The small cell here may include such as a Metro cell, a Micro cell, a Pico cell, or a Femto cell; and these small cells have the characteristics of having a small coverage and a low transmitting power, and may be applicable for providing high-rate data transmission services.

Exemplarily, a communication system 100 to which the embodiments of the disclosure are applied is as illustrated in FIG. 1. The communication system 100 may include a network device 110. The network device 110 may be a device communicating with a terminal device 120 (or referred to as a communication terminal, or a terminal). The network device 110 may provide communication coverage for a specific geographical area, and may communicate with the terminal device within the coverage.

FIG. 1 exemplarily illustrates a network device and two terminal devices. Optionally, the communication system 100 may include multiple network devices, and there may be another number of terminal devices within the coverage of each network device, which is not limited in the embodiments of the disclosure.

Optionally, the communication system 100 may further include other network entities such as a network controller and a mobility management entity, which is not limited in the embodiments of the disclosure.

It is to be understood that devices having a communication function in the network/system in the embodiments of the disclosure may be referred to as a communication device. With the communication system 100 illustrated in FIG. 1 as an example, the communication devices may include a network device 110 and terminal devices 120 that have a communication function. The network device 110 and the terminal devices 120 may be particular devices described above, which will not be described herein again. The communication devices may further include other devices in the communication system 100, for example a network controller, a mobility management entity and other network entities, which is not limited in the embodiments of the disclosure.

It is to be understood that the terms “system” and “network” herein are often used exchangeably. The term “and/or” herein merely describes a relation between associated objects, representing that three relations may exist. For example A and/or B may represent following three cases: existence of A alone, existence of both A and B, and existence of B alone. The character “/” generally indicates that the contextual objects are in an “or” relationship.

It is to be understood that “indicate” referred to in the embodiments of the disclosure may be direct indication or indirect indication, or may refer to that there is an association relationship. By way of example, “A indicates B” may refer to that A directly indicates B, for example B may be acquired through A. “A indicates B” may also refer to that A indirectly indicates B, for example, A indicates C and B may be acquired through C. “A indicates B” may also refer to that there is an association relationship between A and B.

In the description of the embodiments of the disclosure, the term “correspond” may mean that there is a direct correspondence or indirect correspondence between two objects, or may mean that there is an association relationship between the two object, or may mean a relationship that one object indicates or is indicated by another object or a relationship that one object configures or is configured by another object.

In the embodiments of the disclosure, “predefined” may be realized by codes or forms prestored in a device (for example, a terminal device and a network device) or in other ways that can be used to indicate relevant information. The particular implementation is not limited in the disclosure. For example, “predefined” may refer to being defined in a protocol.

In the embodiments of the disclosure, the “protocol” may refer to specification protocols in the field of communications, for example long-term evolution (LTE) protocols, new radio (NR) protocols or relevant protocols applied in future communication systems, which is not limited in the embodiments of the disclosure.

For better understanding of the embodiments of the disclosure, neural networks and machine learning related to the disclosure are described.

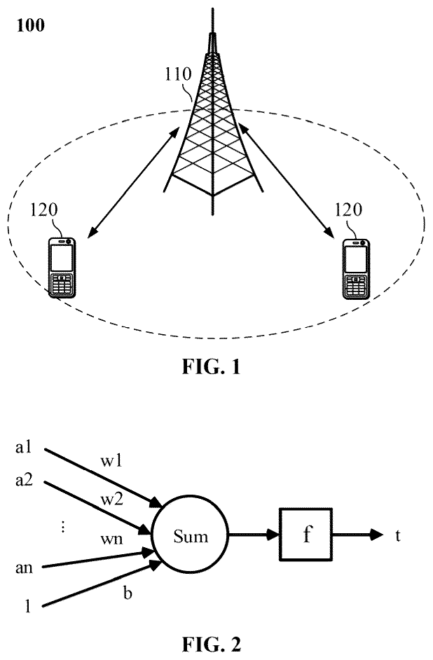

A Neural Network (NN) is a computation model composed of multiple neuron nodes connected to each other. A connection between nodes represents a weighted value from an input signal to an output signal, which is referred to as a weight. Each node performs weighted summation (SUM) on different input signals and generates an output through a specific activation function (f). FIG. 2 illustrates a schematic diagram of a neuron structure, where a1, a2, . . . , and an represent input signals, w1, w2, . . . , and wn represent weights, f represents an activation function, and t represents an output.

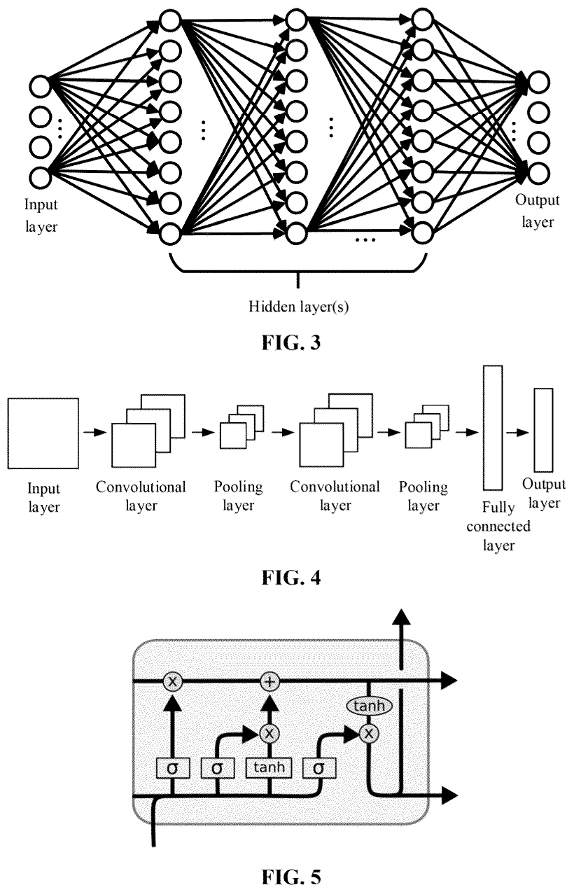

A simple neural network, as illustrated in FIG. 3, includes an input layer, hidden layers and an output layer. Through different connection methods, weights and activation functions of multiple neurons, different outputs may be generated, and then the mapping relationships from inputs to outputs may be fitted. Each node in a current stage is connected to all nodes in a next stage. The neural network is a fully-connected neural network, and may also be referred to as a deep neural network (DNN).

A basic structure of a Convolutional Neural Network (CNN) includes: an input layer, multiple convolutional layers, multiple pooling layers, a fully connected layer and an output layer, as illustrated in FIG. 4. Each neuron of a convolution kernel in a convolutional layer is locally connected to an input of the neuron, and a local maximum or average feature of a convolutional layer is extracted by introducing a pooling layer, which effectively reduces parameters of the network and mines the local features, so that the convolutional neural network can converge quickly and obtain excellent performance.

A deep neural network with multiple hidden layers is used in deep learning, which greatly improves the capability of the network in feature learning, and enables fitting complex nonlinear mappings from inputs to outputs; therefore, deep learning is widely applied in fields of speech processing and image processing. Besides a deep neural network, the deep learning further includes basic structures such as a convolutional neural network (CNN) and a recurrent neural network (RNN) for different tasks.

A basic structure of a Convolutional Neural Network includes: an input layer, multiple convolutional layers, multiple pooling layers, a fully connected layer and an output layer, as illustrated in FIG. 4. Each neuron of a convolution kernel in a convolutional layer is locally connected to an input of the neuron, and a local maximum or average feature of a convolutional layer is extracted by introducing a pooling layer, which effectively reduces parameters of the network and mines the local features, so that the convolutional neural network can converge quickly and obtain excellent performance.

An RNN is a neural network that models sequential data, and has made remarkable achievements in the field of natural language processing, such as machine translation, speech recognition and other applications. Specifically, the network device memorizes information of a past moment and uses same in calculation of a present output, that is, nodes of the hidden layers are no longer unconnected but connected with each other, and inputs of the hidden layers include not only the input layer but also the output of the hidden layers at a previous moment. Commonly used RNNs include structures such as a Long Short-Term Memory (LSTM) unit and a gated recurrent unit (GRU). FIG. 5 illustrates a basic structure of an LSTM unit, which may include a tanh activation function. Different from the RNNs which consider only a latest state, cell states of the LSTM decide which states should be reserved, and which states should be forgotten, remedying the defects of traditional RNNs in long-term memory.

For better understanding of the embodiments of the disclosure, beam management related to the disclosure will be described.

In a new radio (NR) system, communication in a millimeter-wave frequency range has been introduced, and a corresponding beam management mechanism is also introduced, which may include uplink beam management and downlink beam management. Downlink beam management includes procedures such as downlink beam sweeping, optimal beam reporting at a UE side, and downlink beam indication at a network side.

A downlink beam sweeping procedure may refer to that, the network device sweeps different transmitting beam directions through downlink reference signals. The UE may perform measurements using different receiving beams, so as to traverse all beam pairs. The UE calculates a Layer1 Reference Signal Receiving Power (L1-RSRP) value corresponding to each beam pair.

The downlink reference signals include a Synchronization Signal Block (SSB) and/or a Channel State Information Reference Signal (CSI-RS).

For better understanding of the embodiments of the disclosure, beam management related to the disclosure will be described.

In a new radio (NR) system, communication in a millimeter-wave frequency range has been introduced, namely a beam management mechanism is introduced, including for example uplink beam management and downlink beam management. The downlink beam management mechanism includes procedures such as downlink beam sweeping, beam measurement and reporting of UE, and downlink beam indication of a network device.

The downlink beam sweeping procedure may include 3 procedures, namely, P1, P2 and P3 procedures. In the P1 procedure, a network device sweeps different transmitting beams, and a UE sweeps different receiving beams. In the P2 procedure, the network device sweeps different transmitting beams, and the UE uses a same receiving beam. In the P3 procedure, the network device uses a same transmitting beam, and the UE sweeps different receiving beams. Generally, the network device completes the beam sweeping procedure by transmitting downlink reference signals. Optionally, the downlink reference signals may include but is not limited to a Synchronization Signal Block (SSB) and/or a Channel State Information Reference Signal (CSI-RS).

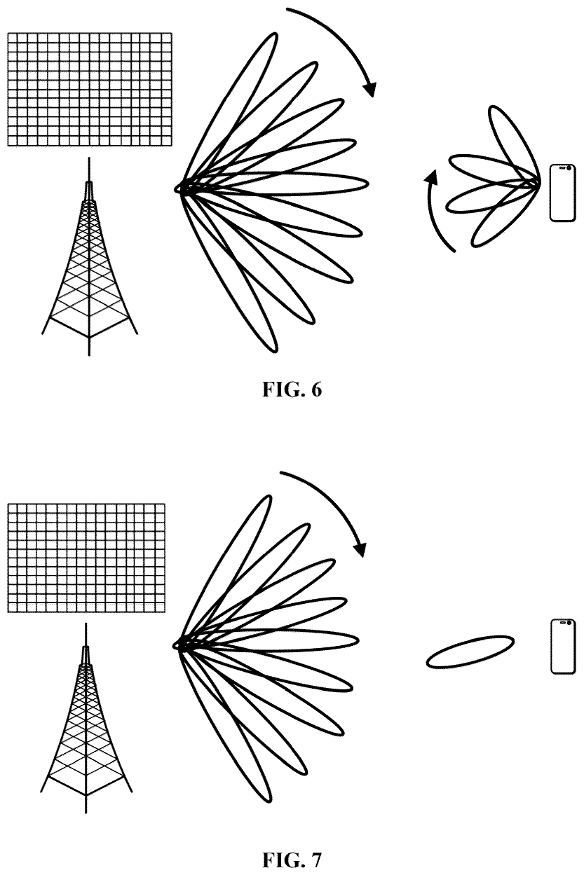

FIG. 6 illustrates a schematic diagram of the P1 procedure (or referred to as a downlink full-sweeping procedure). FIG. 7 illustrates a schematic diagram of the P2 procedure. FIG. 8 illustrates a schematic diagram of the P3 procedure.

As illustrated in FIG. 6, in the P1 procedure, the network device traverses all transmitting beams to transmit downlink reference signals, and the UE side traverses all receiving beams to perform measurement and determines corresponding measurement results.

As illustrated in FIG. 7, in the P2 procedure, the network device traverses all transmitting beams to send downlink reference signals, and the UE side performs measurement using a specific receiving beam and determines corresponding measurement results.

As illustrated in FIG. 8, in the P3 process, the network device may transmit a downlink reference signal using a specific transmitting beam, and the UE side traverses all receiving beams to perform measurement and determines corresponding measurement results.

Beam reporting means that the UE measures different beams or beam pairs to obtain measurement results, selects K transmitting beams with optimal measurement results, and reports the selected transmitting beams to the network device.

After learning the optimal beams reported by the terminal device, the network device may carry a Transmission Configuration Indicator (TCI) state (containing a downlink reference signal as a reference transmitting beam) in a Media Access Control (MAC) or Downlink Control Information (DCI) signaling to complete beam indication to the UE, and the UE uses a receiving beam corresponding to the transmitting beam to perform downlink receiving.

For the downlink full-sweeping procedure, namely the P1 procedure, the UE needs to traverse all combinations of the transmitting beams and the receiving beams, and thus lots of overhead and delay will be brought. For example, the network device deploys 64 different downlink transmitting beams in the FR2 frequency range (carried by at most 64 SSBs). In receiving, the UE uses multiple antenna panels (including only one receiving beam panel) to sweep receiving beams simultaneously, and each antenna panel has 4 receiving beams, then the UE needs to measure at least 256 beam pairs, thus requiring downlink resource overhead of 256 resources.

From the perspective of time, each SSB cycle is about 20 ms, then 4 SSB cycles are needed to complete the measurement of 4 receiving beams (assuming that multiple receiving antenna panels may perform beam sweeping), which needs at least 80 ms.

Therefore, how to reduce the overhead and delay of beam sweeping is an urgent problem to be solved.

For convenience of understanding the technical solution of the embodiments of the disclosure, the technical solution of the disclosure will be described in detail via particular embodiments. Any combination formed by the above relevant technologies as optional solutions and the technical solutions of the embodiments of the disclosure shall fall within the scope of protection of the embodiments of the disclosure. The embodiments of the disclosure include at least part of the following content.

Provided are a method for wireless communication, a terminal device and a network device, which are beneficial to reducing overhead and delay caused by a beam sweeping procedure.

Through the technical solutions, a terminal device or a network device can predict a target spatial filter(s) based on a model, so that the network device and the terminal device do not need to sweep all spatial filters in a predictive spatial filter set, which is beneficial to reducing sweeping overhead and delay.

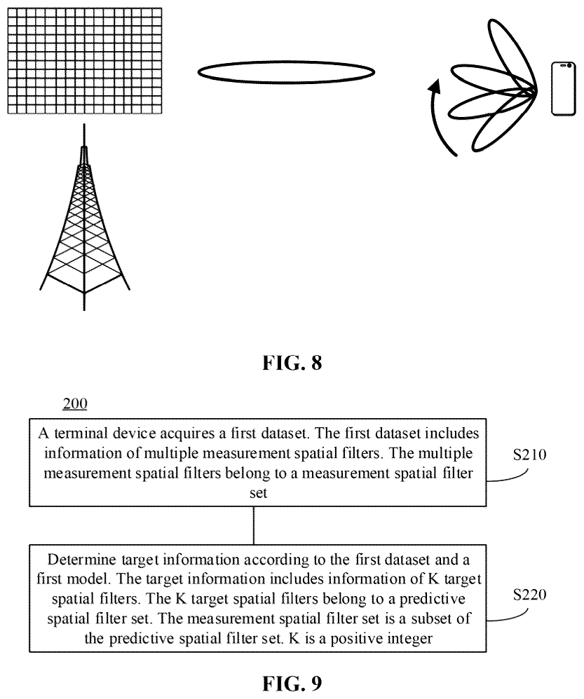

FIG. 9 illustrates a schematic diagram of a method 200 for wireless communication according to embodiments of the disclosure. As illustrated in FIG. 9, the method includes following operations S210 to S220.

At S210, a terminal device acquires a first dataset. The first dataset includes information of multiple measurement spatial filters. The multiple measurement spatial filters belong to a measurement spatial filter set.

At S220, target information is determined according to the first dataset and a first model. The target information includes information of K target spatial filters. The K target spatial filters belong to a predictive spatial filter set. The measurement spatial filter set is a subset of the predictive spatial filter set. K is a positive integer.

In some embodiments of the disclosure, a spatial filter may also be referred to as a beam, a beam pair, a spatial relation, spatial setting, a spatial domain filter, or a reference signal.

In some embodiments, the predictive spatial filter set may be a spatial filter set configured by a network device, or a complete set of spatial filters, or a spatial filter set used for prediction; namely, the terminal device may predict a target spatial filter(s) in the predictive spatial filter set based on the first model.

Optionally, the predictive spatial filter set may be a predictive beam pair set, a predictive transmitting beam set, or a predictive receiving beam set.

In some embodiments, the measurement spatial filter set may be a spatial filter set for measurement, or an actually measured spatial filter set, or an actually swept spatial filter set. Namely, a measurement spatial filter may be a spatial filter for measurement, or an actually measured spatial filter, or an actually swept spatial filter.

Optionally, the measurement spatial filter set may be a measurement beam pair set, a measurement transmitting beam set, or a measurement receiving beam set.

In some embodiments, the measurement spatial filter set may be a subset of the predictive spatial filter set.

Therefore, in the embodiments of the disclosure, the terminal device only needs to measure a portion of spatial filters in the predictive spatial filter set, and can predict the target spatial filters in the predictive spatial filter set according to measurement results of the portion of spatial filters based on the first model, without the need of sweeping all the spatial filters in the predictive spatial filter set, which is beneficial to reducing sweeping overhead and delay.

In some embodiments, the measurement spatial filters are one or more spatial filter pairs, and the spatial filter pair(s) include(s) a transmitting spatial filter(s) (a Tx spatial filter(s) or a Tx spatial domain filter(s)) and a receiving spatial (s) (an Rx spatial filter(s), or an Rx spatial domain filter(s)).

For example, the measurement spatial filters are one or more beam pairs (or Tx-Rx beam pair(s)) including a transmitting beam(s) (Tx beam(s)) and a receiving beam(s) (Rx beam(s)).

In some other embodiments, the measurement spatial filter(s) is/are a transmitting spatial filter(s) (a Tx spatial filter(s), or a Tx spatial domain filter(s)).

For example, the measurement spatial filter(s) is/are a transmitting beam(s) (Tx beam(s)).

In some other embodiments, the measurement spatial filter(s) is/are a receiving spatial filter(s) (an Rx spatial filter(s), or an Rx spatial domain filter(s)).

For example, the measurement spatial filter(s) is/are a receiving beam(s) (Rx beam(s)).

In some embodiments, the information of the measurement spatial filter(s) includes identification information (for example, beam index(es), beam pair index(es), or Tx-Rx pair index(es) of the measurement spatial filter(s) and/or a measurement result(s) of the measurement spatial filter(s).

In some embodiments, the K target spatial filters may be considered as optimal spatial filter(s) in the predictive spatial filter set. Optionally, the optimal spatial filter(s) may be spatial filter(s) satisfying some condition in the predictive spatial filter set.

For example, the K target spatial filters may be spatial filters with measurement results satisfying a first threshold in the predictive spatial filter set, or the K target spatial filters may be K spatial filters with highest (or optimal) measurement results in the predictive spatial filter set.

Optionally, the first threshold may be configured by the network device or may be predefined.

Optionally, the measurement results satisfying the first threshold may include: the measurement results being greater than the first threshold, or the measurement results being greater than or equal to the first threshold.

In some embodiments, the target spatial filters are one or more spatial filter pairs, and each spatial filter pair includes a transmitting spatial filter (a Tx spatial filter or a Tx spatial domain filter) and a receiving spatial filter (an Rx spatial filter, or an Rx spatial domain filter). When the first model is used to predict an optimal spatial filter pair, the purpose is the same as that of the P1 procedure described above.

For example, the target spatial filters are one or more beam pair (Tx-Rx beam pair) including a transmitting beam (Tx beam) and a receiving beam (Rx beam). That is, the first model may be used to predict an optimal beam pair.

In some other embodiments, the target spatial filters are transmitting spatial filters. When the first model is used to predict an optimal transmitting spatial filter, the purpose is the same as that of the P2 procedure described above.

For example, the target spatial filter(s) is/are a transmitting beam(s) (Tx beam(s)). That is, the first model may be used to predict an optimal transmitting beam(s).

In some other embodiments, the target spatial filter(s) is/are a receiving spatial filter(s). When the first model is used to predict an optimal receiving spatial filter(s), the purpose is the same as of the P3 procedure described above.

For example, the target spatial filter(s) is/are a receiving beam(s) (Rx beam(s)). That is, the first model may be used to predict an optimal receiving beam(s).

In some embodiments, the information of the target spatial filter(s) includes identification information (for example, beam indexes or beam pair indexes) of the target spatial filter(s) and/or measurement results of the target spatial filter(s).

In some embodiments, the K target spatial filters belong to the predictive spatial filter set, but do not necessarily belong to the measurement spatial filter set.

It is to be understood that in the embodiments of the disclosure, measurement results of spatial filters in the measurement spatial filter set are obtained by actual measurement, and measurement results of spatial filters in the predictive spatial filter set that do not belong to the measurement spatial filter set are predicted by the terminal device based on the first model.

In some embodiments of the disclosure, the measurement results of the spatial filters may include, but are not limited to, at least one of following: a Layer1 Reference Signal Receiving Power (L1-RSRP), a Layer1 Reference Signal Receiving Quality (L1-RSRQ), and a Layer1 Signal to Interference plus Noise Ratio (L1-SINR).

It is to be noted that, in the embodiments of the disclosure, the predictive spatial filter set may also be referred to as a set A, and the measurement spatial filter set may also be referred to as a set B.

It is to be noted that, the particular implementation of the first model is not limited in the disclosure. For example the first model may be implemented as a CNN or an RNN, or may be implemented as other neural networks.

In some embodiments, the first model includes a model A and a model B. The model A is configured to output identification information of the K target spatial filters, such as indexes of K optimal beams or beam pairs. The model B is configured to output measurement results of the K spatial filters, for example measurement results of the K optimal beams or beam pairs. A same input is used for both the model A and the model B, namely the first dataset.

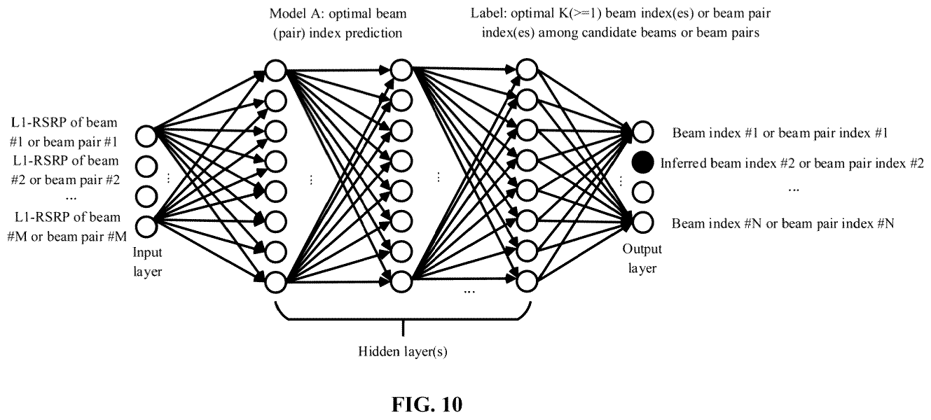

FIG. 10 illustrates an example of a model structure and an input-output relationship of a model A according to embodiments of the disclosure.

As illustrated in FIG. 10, an input of the model A may be indexes of multiple beams or beam pairs and corresponding measurement results. Labels used by the model may be indexes of K beams or beam pairs with optimal measurement results. An output of the model A may be the indexes of K beams or beam pairs with optimal measurement results.

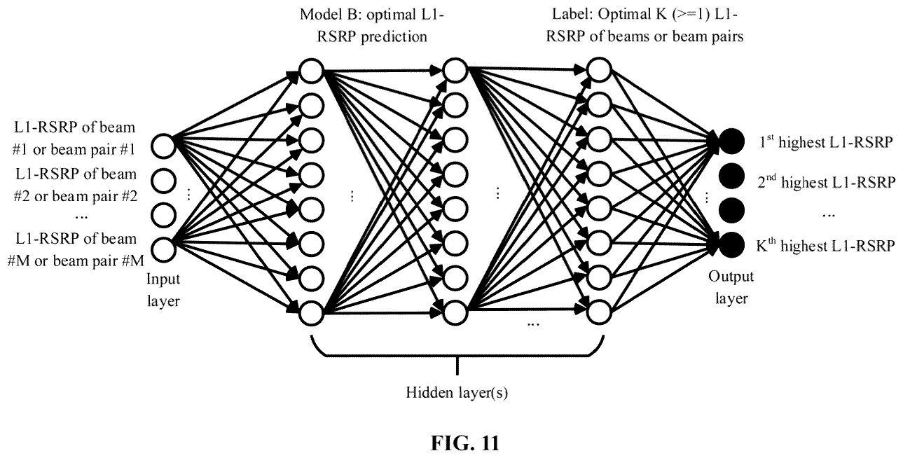

FIG. 11 illustrates an example of a model structure and an input-output relationship of a model B according to embodiments of the disclosure.

As illustrated in FIG. 11, an input of the model B may be indexes of multiple beams or beam pairs and corresponding measurement results. Labels may be measurement results of K beams or beam pairs with optimal measurement results. An output of the model A may be measurement results of K optimal beams or beam pairs.

It is to be understood that, the number of beams or beam pairs output by the first model inferring optimal beams or beam pairs may be the same as the number of beams or beam pairs labeled during training of the first model, or may be smaller than the number of beams or beam pairs labeled during training of the first model. That is to say, if K beams or beam pairs are labeled during training of the first model, K beams or beam pairs or less may be output when using the first model to infer optimal beams or beam pairs.

It is to be understood that the training method of the first model is not limited in the embodiments of the disclosure. For example, the first model may be trained by the terminal device, or the first model may be trained by the network device and model parameters are transmitted to the terminal device by the network device. Optionally, the first model may be obtained by offline training or online training. It is to be noted that, offline training and online training are not mutually repulsive. For example, the network device may firstly obtain a basic model based on the dataset through offline training. During the usage of the model, with further measurement and/or reporting by the terminal device, the network device may continue to collect more data and perform real-time online training to optimize model parameters to achieve better inference and prediction results.

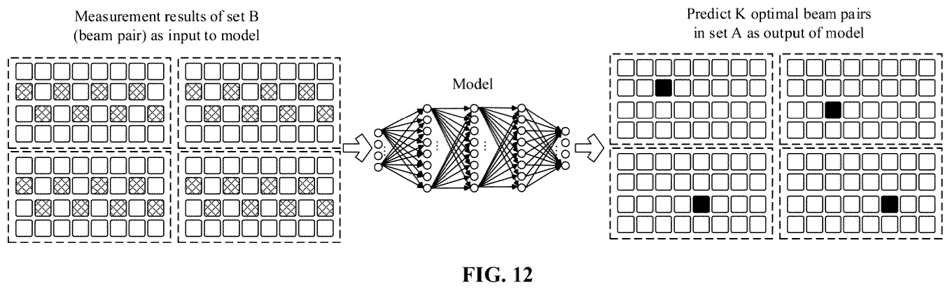

FIG. 12 illustrates an example of inputs and outputs of a first model when the first model is used to predict optimal beam pairs.

As illustrated in FIG. 12, there are transmitting beams in (8) horizontal dimensions and (4) vertical dimensions in each dashed box. Among the 32 transmitting beams, transmitting beams (8 in total) filled with patterns belong to the set B. The transmitting beams in the 4 dashed boxes correspond to different receiving beams respectively. In this case, the set A may include 32*4 beam pairs, and the set B may include 8*4 beam pairs.

Measurement results of the beam pairs in the set B may be used as an input of the first model, so as for the first model to predict optimal beam pairs in the set A. For example, the first model may predict K optimal beam pairs in the set A based on the measurement results of the beam pairs in the set B.

In some embodiments of the disclosure, the method 200 further includes that the terminal device sends first capability information to a network device. The first capability information indicates a spatial filter capability supported by the terminal device, or spatial filter information adapted to the first model.

It is to be understood that in the embodiments of the disclosure, the first capability information may be sent through any uplink information, uplink message, or uplink channel, which is not limited in the disclosure.

In some embodiments, the spatial filter capability supported by the terminal device includes at least one of following: a number of transmitting spatial filters supported by the terminal device; a number of receiving spatial filters supported by the terminal device; and a number of spatial filter pairs supported by the terminal device.

In some embodiments, the spatial filter information adapted to the first model includes, for example, but is not limited to at least one of following: a number of pieces of input information of spatial filters (namely, the number of input dimensions of the first model, or an input scale of the first model) supported by the first model; a scale of a predictive spatial filter set supported by the first model; a set A supported (or recommended) by the terminal device; and a set B supported (or recommended) by the terminal device

For example, the UE may recommend a combination of 64 transmitting beams and 8 receiving beams to construct the set A, and may recommend a combination of 16 transmitting beams and 4 receiving beams to construct the set B.

In some embodiments, the combination of the set A and the set B may be considered as a capability combination of the model.

It is to be understood that, the number of sets A and the number of sets B reported by the terminal device are not limited in the embodiments of the disclosure. For example, one set A and one set B may be reported, or multiple combinations may be reported, each combination being a combination of a respective set A and a respective set B.

In some embodiments, the scale of the predictive spatial filter set supported by the first model may be the scale of the predictive spatial filter set used during model training of the first model.

In some embodiments, the network device may determine, according to the first capability information, the number of receiving beams supported by the terminal device. For example, in the previous example, the network device may determine that a maximum number of receiving beams adapted to the first model at the terminal device side is 8.

In some embodiments, the network device may configure the predictive spatial filter set and the measurement spatial filter set for the terminal device according to the first capability information, or may determine by itself the predictive spatial filter set and the measurement spatial filter set configured for the terminal device.

For example, the network device may determine the set A and the set B recommended by the terminal device as the set A and the set B configured for the terminal device. Alternatively, the network device may adjust the set A and the set B reported by the terminal device, to determine the finally configured set A and set B. Following the previous example, the set A that may be configured by the network device may be a combination of 32 transmitting beams and 8 receiving beams, and the set B that may be configured by the network device may be a combination of 8 transmitting beams and 4 receiving beams.

In some embodiments of the disclosure, the method 200 further includes that the terminal device receives first configuration information from a network device. The first configuration information is configured to configure at least one predictive spatial filter set and/or at least one measurement spatial filter set.

It is to be understood that in the embodiments of the disclosure, the first configuration information may be transmitted through any downlink information, downlink message, or downlink channel, which is not limited in the disclosure. As an example, the first configuration information may be carried in radio resource control (RRC).

Optionally, when the network device configures multiple predictive spatial filter sets and/or multiple measurement spatial filter sets for the terminal device. The multiple predictive spatial filter sets and/or multiple measurement spatial filter sets may be used in different scenarios. For example, the network device may adjust the set A and the set B used for the first model as the terminal device moves, or as a channel environment changes, or as a suitable beam changes, so that the beam prediction can be adapted to changes in the beam environment.

Optionally, when the first configuration information is configured to configure one set A and one set B, the terminal device may perform target spatial filter prediction based on the set A and the set B.

Optionally, when the first configuration information is configured to configure multiple sets A and/or multiple sets B, the terminal device may randomly select a set A and a set B to perform target spatial filter prediction, or the terminal device may activate or update, based on an indication of the network device, the set A and the set B used for target spatial filter prediction. For example, the terminal device receives first indication information from the network device. The first indication information is used to indicate a target set A among multiple sets A and/or a target set B among multiple sets B.

For example, the set A is a complete set of beam pairs, and may contain 64 transmitting beams at the network device side and 8 receiving beams at the terminal device side. The set B, as a subset of beam pairs, may contain for example 16 transmitting beams at the network device side and 4 receiving beams at the terminal device side. In the embodiments of the disclosure, the beam pairs actually measured by the terminal device are reduced from 64*8=512 beam pairs to 16*4=64 beam pairs, thereby reducing the overhead by 1−64/512=87.5%.

It is to be understood that in the embodiments of the disclosure, the first indication information may be transmitted through any downlink information, downlink message, or downlink channel, which is not limited in the disclosure.

As an example, the first indication information is carried in at least one of following signaling: a radio resource control (RRC) signaling, a media Access Control Control Element (MAC CE), and downlink Control Information (DCI).

In some embodiments of the disclosure, the terminal device may further preprocess input information of the first model.

For example, when the number of dimensions of the first dataset is different from the number of input dimensions supported by the first model, the first data set is preprocessed to make the number of dimensions of the input information of the first model be the same as the number of input dimensions supported by the first model.

That is to say, the input information of the first model may be the first dataset, or may be data obtained after processing the first dataset.

Optionally, the number of dimensions of the first dataset may refer to the number of pieces of spatial filter information included in the first dataset.

Optionally, the number of input dimensions supported by the first model may be the number of pieces of input information of spatial filters supported by the first model.

In some embodiments of the disclosure, the operation S220 includes following. In a case that a number of pieces of the information of the multiple measurement spatial filters included in the first dataset is different from a number of pieces of input information of spatial filters supported by the first model (namely the number of input dimensions of the first model), the information of the multiple measurement spatial filters included in the first dataset is processed to obtain target input information. A number of pieces of information of measurement spatial filters included in the target input information is the same as the number of pieces of the input information of the spatial filters supported by the first model.

The operation S220 further includes that the target input information is processed by the first model to obtain the target information.

In some embodiments, in a case that the number of pieces of the information of the multiple measurement spatial filters included in the first dataset is smaller than the number of pieces of the input information of the spatial filters supported by the first model, the information of the multiple measurement spatial filters is upsampled to obtain the target input information.

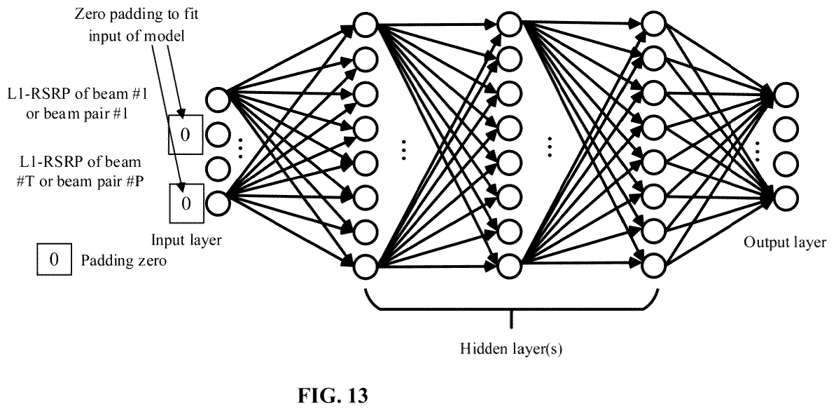

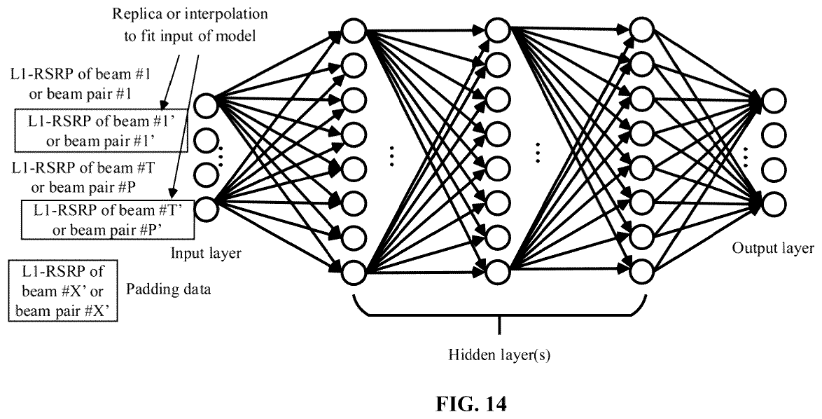

Optionally, the upsampling herein may include, for example, but is not limited to, padding, such as zero padding as illustrated in FIG. 13, or padding by replicating partial data in the first dataset, or padding by linear interpolation as illustrated in FIG. 14.

In some other embodiments, in a case that the number of pieces of the information of the multiple measurement spatial filters included in the first dataset is greater than the number of pieces of the input information of the spatial filters supported by the first model, the information of the multiple measurement spatial filters is downsampled to obtain the target input information.

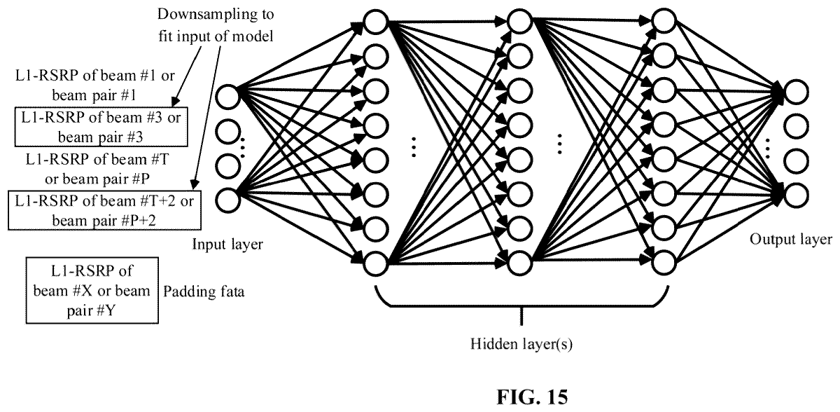

Optionally, the downsampling herein may include, for example, but is not limited to, canceling redundant input by sampling (or punching) or, enabling the number of dimensions of input information to satisfy the number of input dimensions supported by the first model by linear interpolation, as illustrated in FIG. 15.

As an example, if the number of pieces of the information of the multiple measurement spatial filters included in the first dataset is twice the number of pieces of the input information of the spatial filters supported by the first model, the information of measurement spatial filters with odd indexes (or even indexes) in the first dataset may be selected as target input information, and remaining information may be neglected.

In some embodiments of the disclosure, the terminal device may further postprocess output information of the first model.

For example, when the size of a predictive spatial filter set configured by the network device is different from the size of a predictive spatial filter set supported by the first model, the terminal device may postprocess the output information of the first model to enable the precision of the output information of the first model to be the same as the precision of the set A configured by the network device.

That is to say, the target information may be the output information of the first model, or may be data obtained by postprocessing the output information of the first model.

In some embodiments of the disclosure, the operation S220 includes that: in a case that a size of a predictive spatial filter set configured by a network device is different from a size of a predictive spatial filter set supported by the first model (namely, a scale of the predictive spatial filter set supported by the first model), output information of the first model is processed to obtain the target information. The output information includes information of K predictive spatial filters.

In some embodiments, in a case that the scale of the predictive spatial filter set configured by the network device is smaller than the scale of the predictive spatial filter set supported by the first model, the information of the K target spatial filters is determined according to the information of the K predictive spatial filters output by the first model and a first mapping relationship. The first mapping relationship is a mapping relationship between spatial filters in the predictive spatial filter set configured by the network device and spatial filters in the predictive spatial filter set supported by the first model.

In some embodiments, the first mapping relationship may be predefined, or may be configured by the network device.

If the predictive spatial filter set configured by the network device includes N spatial filters, and the predictive spatial filter set supported by the first model includes M spatial filters, N being smaller than M, then in some implementations, the M spatial filters in the predictive spatial filter set supported by the first model may be divided into N groups. Each group of spatial filters corresponds to one spatial filter in the predictive spatial filter set configured by the network device. If the spatial filter(s) predicted by the first model belong(s) to a group X in the N groups, the partial filter(s) corresponding to the group X in the predictive spatial filter set configured by the network device is/are target spatial filter(s).

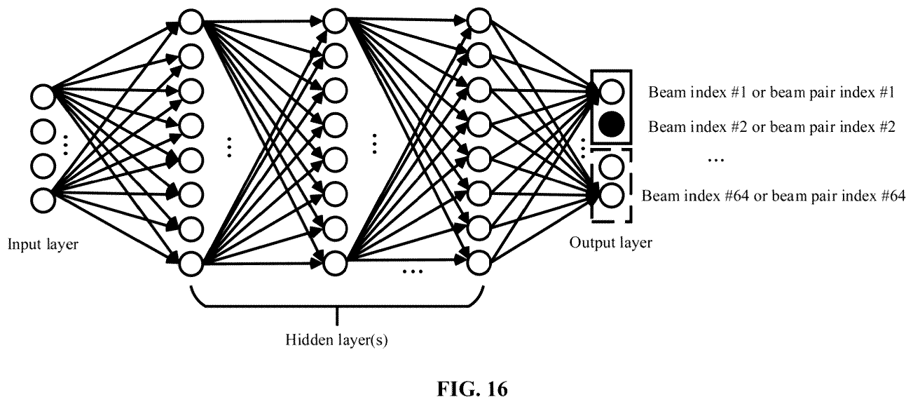

By way of example, as illustrated in FIG. 16, the predictive spatial filter set configured by the network device includes 32 beams or beam pairs, and the predictive spatial filter set supported by the first model includes 64 beams or beam pairs. The 64 beams or beam pairs may be grouped, and each group includes 2 beams or beam pairs. A beam #1 or beam pair #1 and a beam #2 or beam pair #2 correspond to a beam or beam pair in the predictive spatial filter set configured by the network device. If the optimal beam or beam pair predicted by the first model is the beam #2 or beam pair #2, then a beam or beam pair in the predictive spatial filter set configured by the network device corresponding to a group that the beam #2 or beam pair #2 belongs is a target beam or beam pair.

In some other embodiments, in a case that the size of the predictive spatial filter set configured by the network device is greater than the size of the predictive spatial filter set supported by the first model, information of X predictive spatial filters is determined according to the information of the K predictive spatial filters predicted by the first model and a second mapping relationship. The second mapping relationship is a mapping relationship between spatial filters in the predictive spatial filter set configured by the network device and spatial filters in the predictive spatial filter set supported by the first model, X being greater than K.

The information of the K target spatial filters is determined from the information of X predictive spatial filters.

For example, K pieces of information are randomly selected from the information of the X predictive spatial filters as the information of K target spatial filters.

In some embodiments, the second mapping relationship may be predefined, or may be configured by the network device.

If the predictive spatial filter set configured by the network device includes N spatial filters, and the predictive spatial filter set supported by the first model includes M spatial filters, N being greater than M, then in some implementations, the N spatial filters in the predictive spatial filter set configured by the network device may be divided into M groups. Each group of spatial filters corresponds to one spatial filter in the predictive spatial filter set supported by the first model. If the spatial filters predicted by the first model include a spatial filter #X, and the spatial filter #X corresponds to a group Z in the M groups, then the terminal device may select a spatial filter from the group Z as a target spatial filter.

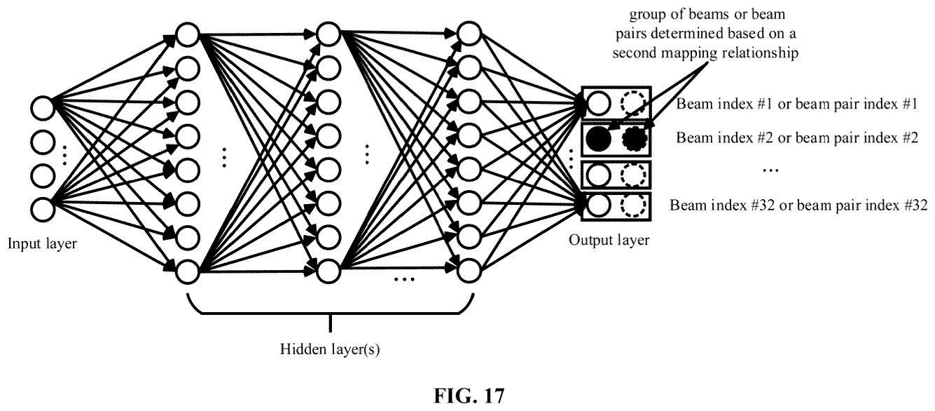

By way of example, as illustrated in FIG. 17, the predictive spatial filter set supported by the first model includes 32 beams or beam pairs, and the predictive spatial filter set configured by the network device includes 64 beams or beam pairs. The 64 beams or beam pairs may be divided into 32 groups, and each group includes 2 beams or beam pairs. If an optimal beam or beam pair predicted by the first model is the beam #2 or beam pair #2, the terminal device may further select a beam or beam pair from a group corresponding to the beam #2 or beam pair #2 among the 32 groups as a target beam or beam pair.

In some embodiments of the disclosure, the method 200 further includes that: the terminal device sends first report information to the network device. The first report information indicates the information of the K target spatial filters or information of K transmitting spatial filters corresponding to the K target spatial filters.

Situation 1: the K target spatial filters are K spatial filter pairs. That is, the first model is used for predicting optimal spatial filter pairs.

In this situation, the first report information indicates information of the K spatial filter pairs or information of transmitting spatial filters of the K spatial filter pairs.

For example, the K target spatial filters are K beam pairs, and the first report information may indicate information of the K beam pairs or may indicate information of transmitting beams of the K beam pairs.

Method 1: the information of spatial filter pairs is reported.

In some embodiments, the first report information includes identification information of the K spatial filter pairs and measurement results of the K target spatial filter pairs.

For example, the K target spatial filters are K beam pairs, and the first report information includes indexes of the K beam pairs and measurement results of the K beam pairs.

As a specific example, if the set A contains 256 beam pairs, then each beam pair has an index. The index ranges from 0 to 255 and has a length of 8 bits. Then, it needs a length of at least 8*K bits to report the indexes of the K optimal beam pairs.

Optionally, in the first report information, the information of the K spatial filter pairs are arranged in a descending order of the measurement results of the K spatial filter pairs.

In some embodiments, the measurement results of the K spatial filter pairs may be indicated in form of a reference measurement result and differential measurement results. For example, the absolute value of the measurement result of a spatial filter pair may be reported, and the measurement results of the other spatial filter pairs may be indicated in the form of differential values relative to the absolute value. Optionally, the reference measurement result may be a highest measurement result.

Table 1 gives an example of a report form in which the terminal device reports 4 beam pairs (i.e., K=4) and measurement results corresponding thereto. Tx-Rx beam pair #n represents a reported index of a beam pair, n=1, 2, 3, 4. RSRP #1 represents the absolute value of an L1-RSRP corresponding to Tx-Rx beam pair #1. Differential RSRP #2 represents a differential value of an L1-RSRP corresponding to Tx-Rx beam pair #2 relative to RSRP #1. Differential RSRP #3 represents a differential value of an L1-RSRP corresponding to Tx-Rx beam pair #3 relative to RSRP #1. Differential RSRP #4 represents a differential value of an L1-RSRP corresponding to Tx-Rx beam pair #4 relative to RSRP #1.

It is to be understood that, the specific report form in which the terminal device reports the measurement results is not limited in the embodiments of the disclosure. For example, the terminal device may also report the absolute value of the measurement result of each of the K beam pairs directly, but the disclosure is not limited thereto.

TABLE 1

| CSI report number | CSI field(s) |
|---|---|
| CSI report # n | Tx-Rx beam pair #1 |
| | Tx-Rx beam pair #2 |
| | Tx-Rx beam pair #3 |
| | Tx-Rx beam pair #4 |
| | RSRP #1 |
| | Differential RSRP #2 |
| | Differential RSRP #3, |
| | Differential RSRP #4 |

Method 2: the information of transmitting spatial filters of spatial filter pairs is reported.

In some embodiments, the first report information includes identification information of the K transmitting spatial filters and measurement results of the K target spatial filter pairs.

For example, the K spatial filter pairs are K beam pairs, and the first report information includes indexes of transmitting beams of the K beam pairs and measurement results of the K beam pairs. Since the network device has no need to know the information of the receiving beams at the terminal device side, in this implementation, the terminal device may report only the information of the transmitting beams, which is beneficial to reducing the reporting overhead of the terminal device. The terminal device knows the receiving beams corresponding to reported transmitting beams. The terminal device may store information of the receiving beams in the beam pairs, and when the network device indicates a certain transmitting beam among the reported transmitting beams, the terminal device may use a corresponding receiving beam to perform signal receiving.

Following the previous example, if the set A contains 256 beam pairs, including 64 transmitting beams, then an index of a transmitting beam ranges from 0 to 63 and has a length of 6 bits. Then, it needs a length of at least 6*K bits to report the indexes of transmitting beams of the K optimal beam pairs.

Optionally, in the method 2, the information of the K spatial filter pairs may also be arranged in a descending order of the measurement results of the K spatial filter pairs, and the difference lies in that the beam pair index in the report form is replaced with the index of the transmitting beam of the beam pair.

Situation 2: the K target spatial filters are K transmitting spatial filters. That is, the first model is used for predicting optimal transmitting spatial filters.

In this situation, the first report information includes identification information of the K transmitting spatial filters and measurement results of the K transmitting spatial filters.

For example, the first report information includes indexes of K transmitting beams and measurement results of the K transmitting beams.

Optionally, in the first report information, the information of the K transmitting spatial filters are arranged in a descending order of the measurement results of the K transmitting spatial filters. In this situation, the report form of the first reporting information is similar to that in situation 1, and the difference lies in that the beam pair index in the report form is replaced with a transmitting beam index, which is not described here again for simplicity.

Situation 3: the K target spatial filters are K receiving spatial filters. That is, the first model is used for predicting optimal receiving spatial filters.

Since the network device has no need to know the information of the receiving beams at the terminal device side, the terminal device may not perform reporting in this situation.

In some embodiments of the disclosure, the method 200 further includes that: the terminal device receives second indication information from the network device. The second indication information indicates at least one target spatial filter among the K target spatial filters or at least one transmitting spatial filter corresponding to the at least one target spatial filter.

In some embodiments, if the first report information includes information of K spatial filter pairs, the second indication information indicates a target spatial filter pair(s) among the K spatial filter pairs, or the second indication information indicates a transmitting spatial filter(s) of the target spatial filter pair(s). The target spatial filter pair(s) include(s) one or more spatial filter pairs among the K spatial filter pairs.

For example, the first report information includes information of K beam pairs, and the second indication information indicates a target beam pair among the K beam pairs or indicates a transmitting beam of the target beam pair. The target beam pair includes one or more beam pairs among the K beam pairs.

In some other embodiments, if the first report information includes information of K transmitting spatial filters, the second indication information indicates one or more transmitting spatial filters among the K transmitting spatial filters.

For example, the first report information includes information of K transmitting beams, and the second indication information indicates a target transmitting beam among the K transmitting beams. The target transmitting beam includes one or more transmitting beams among the K transmitting beams.

Optionally, if the network device indicates a transmitting beam, the transmitting beam may be indicated by indicating a TCI state.

For example, the second indication information indicates at least one transmission configuration indication (TCI) state, and the at least one TCI state corresponds to at least one transmitting spatial filter. The at least one transmitting spatial filter is a transmitting spatial filter(s) selected by the network device, or a transmitting spatial filter(s) of a spatial filter pair(s) selected by the network device.

Optionally, in some embodiments of the disclosure, after receiving the first report information from the terminal device, the network device may also perform secondary beam sweeping to determine the performance of the K target spatial filters reported by the terminal device.

For example, the network device may trigger a beam sweeping procedure including the K target spatial filters, and the terminal device measures the K target spatial filters and further feeds back measurement results of the K target spatial filters to the network device.

Optionally, the network device may select a spatial filter according to the measurement results of the K target spatial filters obtained by the secondary sweeping. The spatial filter selected by the network device is further indicated by the second indication information.

That is to say, the spatial filter indicated by the second indication information may be selected by the network device according to the first report information, or may be selected by the network device according to measurement results of the secondary sweeping.

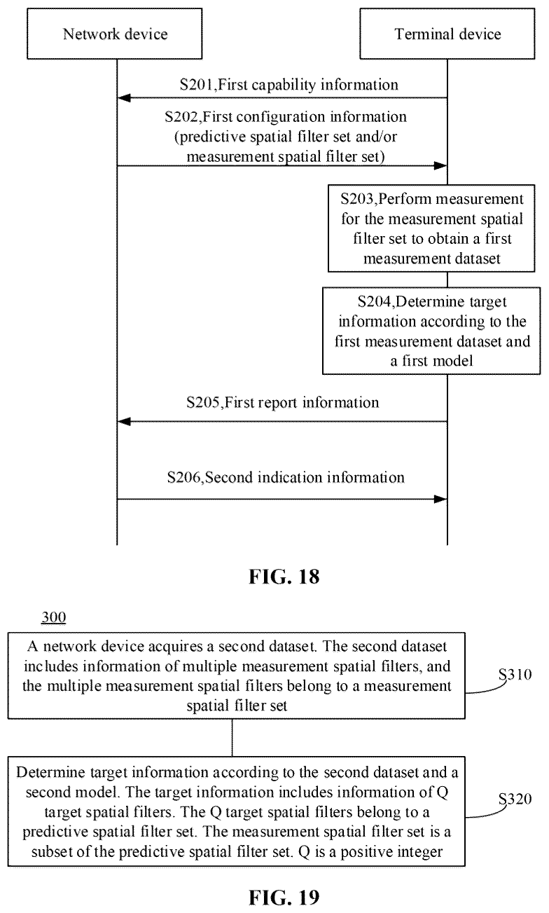

Hereinafter, a specific implementation process of performing spatial filter prediction by the terminal device when a model for spatial filter prediction is deployed at the terminal device side is described in conjunction with FIG. 18. As illustrated in FIG. 18, the implementation process may include at least some of following operations S201 to S206.

At S201, the terminal device sends first capability information to a network device.

The specific implementation of the first capability information may refer to relevant description of previous embodiments, which will not be described here again.

At S202, the network device sends first configuration information to the terminal device.

The first configuration information is configured to configure a predictive spatial filter set and/or a measurement spatial filter set.

In some embodiments, the first configuration information may be configured to configure a predictive spatial filter set and a measurement spatial filter set.

In some other embodiments, the first configuration information indicates multiple predictive spatial filter sets and multiple measurement spatial filter sets, or indicates multiple predictive spatial filter sets and one measurement spatial filter set, or indicates one predictive spatial filter set and multiple measurement spatial filter sets.

Optionally, when the network device configures multiple predictive spatial filter sets and/or multiple measurement spatial filter sets for the terminal device, the network device may indicate a target predictive spatial filter set among the multiple predictive spatial filter sets and/or a target measurement spatial filter set among the multiple measurement spatial filter sets. Specific implementation may refer to relevant description of the first indication information previously, which will not be described here again for simplicity.

At S203, the terminal device performs measurement based on a measurement spatial filter set, to obtain a first dataset.

For example, the terminal device performs measurement for all spatial filters in the measurement spatial filter set, to obtain the first dataset.

At S204, the terminal device determines target information according to the first dataset and a first model.

Optionally, in S204, the terminal device may further preprocess the first dataset. The specific implementation may refer to relevant description of previous embodiments, which will not be described here again.

Optionally, in S204, the terminal device may further postprocess output information of the first model. The specific implementation may refer to relevant description of previous embodiments, which will not be described here again.

At S205, the terminal device sends first report information to the network device, for reporting information of predictive spatial filters.

The specific implementation of the first report information may refer to relevant description of previous embodiments, which will not be described here again.

At S206, the network device sends second indication information to the terminal device. The second indication information indicates a spatial filter selected by the network device.

The specific implementation of the second indication information may refer to relevant description of previous embodiments, which will not be described here again.

Hereinafter, specific implementations of three prediction scenarios are described in conjunction with embodiments 1 to 3.

Embodiment 1: spatial filter pair prediction, or beam pair prediction. The purpose of beam pair prediction is the same as that of the P1 procedure, namely to find a suitable beam pair in the process that both the terminal device and the network device perform beam sweeping.

Specifically, at least some of following operations 1 to 6 may be included.

At operation 1, the terminal device sends first capability information to the network device.

Optionally, the first capability information indicates beam or beam pair related information supported by the terminal device, or beam or beam pair related information associated with the first model. Relevant description of previous embodiments may be referred to for specific implementation.

As an example, the first capability information indicates a predictive beam pair set and a measurement beam pair set.

At operation 2, the network device sends first configuration information to the terminal device.

The first configuration information is configured to configure one or more predictive beam pair sets and one or more measurement beam pair sets.

In some embodiments, the first configuration information may be configured to configure a combination of a predictive beam pair set and a measurement beam pair set.

In some other embodiments, the first configuration information indicates multiple combinations, each combination being a combination of a respective predictive beam set and a respective measurement beam set.

Optionally, when the network device configures multiple combinations for the terminal device, each combination being a combination of a respective predictive beam set and a respective measurement beam set, the network device may indicate a target combination of the multiple combinations.

At operation 3, the terminal device performs measurement based on the measurement beam pair set, to obtain a first dataset.

For example, the terminal device performs measurement for all beam pairs in the measurement beam pair set, to obtain the first dataset.

Optionally, the first dataset may include measurement results of all beam pairs in the measurement beam pair set.

At operation 4, the terminal device determines target information according to the first dataset and a first model.

Optionally, in operation 4, when the number of dimensions of the first dataset is different from the number of input dimensions supported by the first model, the terminal device may further preprocess the first dataset. The specific implementation may refer to relevant description of previous embodiments, which will not be described here again.

Optionally, in operation 4, when the number of dimensions of the predictive beam pair set configured by the network device is different from the number of dimensions of the predictive beam pair set supported by the first model, the terminal device may further postprocess output information of the first model. The specific implementation may refer to relevant description of previous embodiments, which will not be described here again.

At operation 5, the terminal device sends first report information to the network device, for reporting information of a predicted beam pair.

For example, the first report information may include identification information of K predicted beam pairs and measurement results of the K beam pairs. Optionally, the information of the K beam pairs may be arranged in a descending order of the measurement results of the K beam pairs.

For another example, the first report information may include identification information of transmitting beams of the K predicted beam pairs and measurement results of the K beam pairs. The measurement results of the K beam pairs are arranged in a descending order.

At operation 6, the network device sends second indication information to the terminal device. The second indication information indicates a beam pair(s) or transmitting beam(s) selected by the network device.

For example, when the first report information includes identification information of K beam pairs, the second indication information may indicate one or more beam pairs among the K beam pairs, for example indicating identification information of the one or more beam pairs.

For another example, when the first report information includes identification information of K beam pairs, the second indication information may indicate a transmitting beam of a target beam pair among the K beam pairs, for example indicating identification information of the transmitting beam of the target beam pair.

For another example, when the first report information includes identification information of K transmitting beams, the second indication information may indicate a target transmitting beam among the K transmitting beams.

Optionally, the network device may indicate a transmitting beam by a TCI state.

Embodiment 2: transmitting spatial filter prediction, or transmitting beam prediction. The purpose of transmitting beam prediction is the same as that of the P2 procedure, namely to find a suitable transmitting beam during transmitting beam sweeping. During beam sweeping, a network device sweeps transmitting beams, and a terminal device uses a fixed receiving beam.

Specifically, at least some of following operations 1 to 6 may be included.

At operation 1, the terminal device sends first capability information to the network device.

Optionally, the first capability information indicates beam or beam pair related information supported by the terminal device, or beam or beam pair related information associated with the first model. Relevant description of previous embodiments may be referred to for specific implementation.

As an example, the first capability information indicates a predictive transmitting beam set and a measurement transmitting beam set.

At operation 2, the network device sends first configuration information to the terminal device.

The first configuration information is configured to configure a predictive transmitting beam set and a measurement transmitting beam set.

In some embodiments, the first configuration information may be configured to configure a combination of a predictive transmitting beam set and a measurement transmitting beam set.

In some other embodiments, the first configuration information indicates multiple combinations, each combination being a combination of a respective predictive transmitting beam set and a respective measurement transmitting beam set.

Optionally, when the network device configures multiple combinations for the terminal device, each combination being a combination of a respective predictive transmitting beam set and a respective measurement transmitting beam set, the network device may indicate a target combination of the multiple combinations.

At operation 3, the terminal device performs measurement based on the measurement transmitting beam set, to obtain a first dataset.

For example, the terminal device performs measurement for all transmitting beams in the measurement transmitting beam set (in this case, the terminal device uses a fixed receiving beam), to obtain the first dataset.

Optionally, the first dataset may include measurement results of all transmitting beams in the measurement transmitting beam set. Here, the measurement result of a transmitting beam may be considered as the measurement result of a beam pair composed of the transmitting beam and the receiving beam used by the terminal device.

At operation 4, the terminal device determines target information according to the first dataset and a first model.

Optionally, in operation 4, when the number of dimensions of the first dataset is different from the number of input dimensions supported by the first model, the terminal device may further preprocess the first dataset. The specific implementation may refer to relevant description of previous embodiments, which will not be described here again.

Optionally, in operation 4, when the number of dimensions of the predictive transmitting beam set configured by the network device is different from the number of dimensions of the predictive transmitting beam set supported by the first model, the terminal device may further postprocess output information of the first model. The specific implementation may refer to relevant description of previous embodiments, which will not be described here again.

At operation 5, the terminal device sends first report information to the network device, for reporting information of a predicted transmitting beam.

For example, the first report information may include identification information of K predicted transmitting beams and measurement results of the K transmitting beams. Optionally, the information of the K transmitting beams may be arranged in a descending order of the measurement results of the K transmitting beams.

At operation 6, the network device sends second indication information to the terminal device. The second indication information indicates a transmitting beam selected by the network device.

For example, the first report information includes identification information of K transmitting beams, and the second indication information may indicate a target transmitting beam among the K transmitting beams.

Optionally, the network device may indicate a transmitting beam by a TCI state.

Embodiment 3: receiving spatial filter prediction, or receiving beam prediction. The purpose of receiving beam prediction is the same as that of the P3 procedure, namely to find a suitable receiving beam during receiving beam sweeping. During the P3 beam sweeping, a network device uses a fixed transmitting beam, and a terminal device sweeps receiving beams.

Specifically, at least some of following operations 1 to 4 may be included.

At operation 1, the terminal device sends first capability information to the network device.

Optionally, the first capability information indicates beam or beam pair related information supported by the terminal device, or beam or beam pair related information associated with the first model. Relevant description of previous embodiments may be referred to for specific implementation.

As an example, the first capability information indicates a predictive receiving beam set and a measurement receiving beam set.

At operation 2, the network device sends first configuration information to the terminal device.

The first configuration information is configured to configure a predictive receiving beam set and a measurement receiving beam set.

In some embodiments, the first configuration information may be configured to configure a combination of a predictive receiving beam set and a measurement receiving beam set.

In some other embodiments, the first configuration information indicates multiple combinations, each combination being a combination of a respective predictive receiving beam set and a respective measurement receiving beam set.

Optionally, when the network device configures multiple combinations for the terminal device, each combination being a combination of a respective predictive receiving beam set and a respective measurement receiving beam set, the network device may indicate a target combination of the multiple combinations.

At operation 3, the terminal device performs measurement based on the measurement receiving beam set, to obtain a first dataset.

For example, the terminal device performs measurement for all receiving beams in the measurement receiving beam set (in this case, the network device uses a fixed transmitting beam), to obtain the first dataset.

Optionally, the first dataset may include measurement results of all receiving beams in the measurement receiving beam set. Here, the measurement results of a receiving beam may be considered as the measurement result of a beam pair composed by the receiving beam and the transmitting beam used by the network device.

At operation 4, the terminal device determines target information according to the first dataset and a first model.

Optionally, in operation 4, when the number of dimensions of the first dataset is different from the number of input dimensions supported by the first model, the terminal device may further preprocess the first dataset. The specific implementation may refer to relevant description of previous embodiments, which will not be described here again.

Optionally, in operation 4, when the number of dimensions of the predictive receiving beam set configured by the network device is different from the number of dimensions of the predictive receiving beam set supported by the first model, the terminal device may further postprocess output information of the first model. The specific implementation may refer to relevant description of previous embodiments, which will not be described here again.

In embodiment 3, since the network device has no need to know the receiving beams at the terminal device side, the terminal device may not have to report the receiving beams.

At the network device side, since the network device uses a fixed transmitting beam for sweeping, the network device also does not have to indicate an Rx beam corresponding to the fixed transmitting beam.

In summary, in the embodiments of the disclosure, the terminal device may predict a target spatial filter based on a model, so that the network device and the terminal device do not need to sweep all spatial filters in a predictive spatial filter set, which is beneficial to reducing sweeping overhead and delay.

In some scenarios, the terminal device may send first capability information to the network device, for reporting beam-related capability information of the terminal device.

In some embodiments, the network device may send first configuration information to the terminal device. The first configuration information is configured to configure a predictive spatial filter set and/or a measurement spatial filter set.

In some embodiments, the terminal device may report to the network device information of a target spatial filter predicted based on a model

Further, based on the report of the terminal device, the network device may indicate a spatial filter selected by the network device or an actually used spatial filter to the terminal device.

FIG. 19 illustrates a schematic diagram of a method 300 for wireless communication according to another embodiment of the disclosure. As illustrated in FIG. 19, the method 300 includes following operations S310 and S320.

At S310, a network device acquires a second dataset. The second dataset includes information of multiple measurement spatial filters, and the multiple measurement spatial filters belong to a measurement spatial filter set.

At S320, the network device determines target information according to the second dataset and a second model. The target information includes information of Q target spatial filters.

The Q target spatial filters belong to a predictive spatial filter set. The measurement spatial filter set is a subset of the predictive spatial filter set. Q is a positive integer.

It is to be understood that specific implementations of the measurement spatial filter set, the predictive spatial filter set, the measurement spatial filter, the target spatial filter, the information of the measurement spatial filter, and the information of the target spatial filter(s) may refer to the related description in the method 200, which will not be described here again for simplicity.

In some embodiments, the specific implementation of the second model may refer to the related implementation of the first model in the method 200, which will not be described here again for simplicity.

In some embodiments of the disclosure, the method 300 further includes that: the network device receives first capability information from a terminal device. The first capability information indicates a spatial filter capability supported by the terminal device. The specific implementation of the first capability information may refer to relevant description of the method 200, which will not be described here again for simplicity.

In some embodiments of the disclosure, the method 300 further includes that: the network device sends first configuration information to a terminal device. The first configuration information is configured to configure at least one predictive spatial filter set and/or at least one measurement spatial filter set. The specific implementation of the first configuration information may refer to relevant description of the method 200, which will not be described here again for simplicity.

Optionally, the first configuration information is carried in a radio resource control (RRC) signaling.

In a particular embodiment, the first configuration information is configured to only configure a measurement spatial filter set.

Specifically, since the model is deployed at the network device side, and using the measurement spatial filter set as the input set of the model and using the prediction spatial filter set as the output set of the model are carried out at the network device side, the network device may configure only the measurement spatial filter set for the terminal device.

In another particular embodiment, the first configuration information may also be configured to configure both the predictive spatial filter set and the measurement spatial filter set.

In some embodiments, the at least one predictive spatial filter set includes multiple predictive spatial filter sets and/or the at least one measurement spatial filter set includes multiple measurement spatial filter sets. The method further includes that: the network device sends first indication information to the terminal device. The first indication information indicates a target predictive spatial filter set among the multiple predictive spatial filter sets and/or a target measurement spatial filter set among the multiple measurement spatial filter sets. The specific implementation of the first indication information may refer to relevant description of the method 200, which will not be described here again for simplicity.

In some embodiments, the first indication information is carried in at least one of following signaling: a radio resource control (RRC) signaling, a media access control control element (MAC CE), and downlink control information (DCI).

In some embodiments, the second dataset is acquired by the network device from the terminal device.

For example, the network device receives second report information from the terminal device. The second report information indicates measurement results of measurement spatial filters in the measurement spatial filter set.

In some embodiments, the second report information includes measurement results of all measurement spatial filters in the measurement spatial filter set. For example, the measurement results of the measurement spatial filters are arranged according to the identification information of the measurement spatial filters.

With the set B including M beam pairs as an example, Table 2 illustrates report forms of M beam pairs and measurement results corresponding thereto. RSRP #1 represents an L1-RSRP corresponding to a Tx-Rx beam pair #1. RSRP #2 represents an L1-RSRP corresponding to a Tx-Rx beam pair #2. RSRP #M represents an L1-RSRP corresponding to a Tx-Rx beam pair

TABLE 2

| CSI report number | CSI field(s) |
|---|---|
| CSI report # n | RSRP #1 of Tx-Rx beam pair #1 in Set B |
| | RSRP #2 of Tx-Rx beam pair #2 in Set B |
| | . . . |
| | RSRP # M of Tx-Rx beam pair # M in Set B |

With the set B including H transmitting beams as an example, Table 3 illustrates report forms of H transmitting beams and measurement results corresponding thereto. RSRP #1 represents an L1-RSRP corresponding to a Tx beam #1. RSRP #2 represents an L1-RSRP corresponding to a Tx beam #2. RSRP #H represents an L1-RSRP corresponding to a Tx beam

TABLE 3

| CSI report number | CSI field(s) |
|---|---|
| CSI report # n | RSRP #1 of Tx beam #1 in Set B |
| | RSRP #2 of Tx beam #2 in Set B |
| | . . . |
| | RSRP # H of Tx beam # H in Set B |

With the set B including receiving beams as an example, Table illustrates report forms of J receiving beams and measurement results corresponding thereto. RSRP #1 represents an L1-RSRP corresponding to an Rx beam #1. RSRP #2 represents an L1-RSRP corresponding to an Rx beam #2. RSRP #J represents an L1-RSRP corresponding to an Rx beam #J.

TABLE 4

| CSI report number | CSI field(s) |
|---|---|
| CSI report # n | RSRP #1 of Rx beam #1 in Set B |
| | RSRP #2 of Rx beam #2 in Set B |
| | . . . |
| | RSRP # J of Rx beam # J in Set B |

In some other embodiments, the second report information includes identification information of all the measurement spatial filters in the measurement spatial filter set and the measurement results of all the measurement spatial filters in the measurement spatial filter set.

Optionally, in the second report information, the measurement results of the measurement spatial filters in the measurement spatial filter set are arranged in a descending order.

With the set B including M beam pairs as an example, Table 5 illustrates report forms of M beam pairs and measurement results corresponding thereto. Tx-Rx beam pair #1 represents an index of a reported beam pair. RSRP #1 represents the absolute value of an L1-RSRP corresponding to Tx-Rx beam pair #1. Differential RSRP #2 represents a differential value of an L1-RSRP corresponding to Tx-Rx beam pair #2 relative to RSRP #1. Differential RSRP #3 represents a differential value of an L1-RSRP corresponding to Tx-Rx beam pair #3 relative to RSRP #1. Differential RSRP #M represents a differential value of an L1-RSRP corresponding to Tx-Rx beam pair #M relative to RSRP #1.

TABLE 5

| CSI report number | CSI field(s) |
|---|---|
| CSI report # n | Tx-Rx beam pair #1 (highest) |
| | Tx-Rx beam pair #2 (2^{nd} highest) |
| | . . . |
| | Tx-Rx beam pair #M (least highest) |
| | RSRP #1 |
| | Differential RSRP #2 |
| | . . . |
| | Differential RSRP #M |

With the set B including H transmitting beams as an example, Table 6 illustrates report forms of H transmitting beams and measurement results corresponding thereto. Tx beam #1 represents an index of a reported transmitting beam. RSRP #1 represents the absolute value of an L1-RSRP corresponding to Tx beam #1. Differential RSRP #2 represents a differential value of an L1-RSRP corresponding to Tx beam #2 relative to RSRP #1. Differential RSRP #3 represents a differential value of an L1-RSRP corresponding to Tx beam #3 relative to RSRP #1. Differential RSRP #H represents a differential value of an L1-RSRP corresponding to Tx beam #H relative to RSRP #1.

TABLE 6

| CSI report number | CSI field(s) |
|---|---|
| CSI report # n | Tx beam #1 (highest) |
| | Tx beam #2 (2^{nd} highest) |
| | . . . |
| | Tx beam #H (least highest) |
| | RSRP #1 |
| | Differential RSRP #2 |
| | . . . |
| | Differential RSRP #H |

With the set B including receiving beams as an example, Table 7 illustrates report forms of J receiving beams and measurement results corresponding thereto. Rx beam #1 represents an index of a reported receiving beam. RSRP #1 represents the absolute value of L1-RSRP corresponding to Rx beam #1. Differential RSRP #2 represents a differential value of an L1-RSRP corresponding to Rx beam #2 relative to RSRP #1. Differential RSRP #3 represents a differential value of an L1-RSRP corresponding to Rx beam #3 relative to RSRP #1. Differential RSRP #J represents a differential value of an L1-RSRP corresponding to Rx beam #J relative to RSRP #1.

TABLE 7

| CSI report number | CSI field(s) |
|---|---|
| CSI report # n | Rx beam #1 (highest) |
| | Rx beam #2 (2^{nd} highest) |
| | . . . |
| | Rx beam #J (least highest) |
| | RSRP #1 |
| | Differential RSRP #2 |
| | . . . |
| | Differential RSRP #J |

In some embodiments of the disclosure, the network device may further preprocess input information of the second model. The specific implementation may refer to relevant description of the method 200, which will not be described here again for simplicity.

For example, when the number of dimensions of the second dataset is different from the number of input dimensions supported by the second model, the second dataset is preprocessed to enable the number of dimensions of the input information of the second model to be the same as the number of input dimensions supported by the second model.

That is to say, the input information of the second model may be the second dataset, or may be data obtained after processing the second dataset.

In some embodiments of the disclosure, the operation S320 includes following. In a case that a number of pieces of the information of the multiple measurement spatial filters included in the second dataset is different from a number of input dimensions of the second model, the information of the multiple measurement spatial filters is processed to obtain target input information. A number of pieces of information of measurement spatial filters included in the target input information is the same as the number of input dimensions of the second model. The second model processes the target input information to obtain the target information.

For example, in a case that the number of pieces of the information of the multiple measurement spatial filters included in the second dataset is smaller than the number of input dimensions of the second model, the information of the multiple measurement spatial filters is upsampled to obtain the target input information.

For another example, in a case that the number of pieces of the information of the multiple measurement spatial filters included in the second dataset is greater than the number of input dimensions of the second model, the information of the multiple measurement spatial filters is downsampled to obtain the target input information.

In some embodiments of the disclosure, the network device may further postprocess output information of the second model. The specific implementation may refer to relevant description of the method 200, which will not be described here again for simplicity.

For example, when the size of a predictive spatial filter set configured by the network device is different from the size of a predictive spatial filter set supported by the second model, the network device may postprocess the output information of the second model to enable the precision of the output information of the second model to be same as the precision of the set A configured by the network device.

That is to say, the target information may be the output information of the second model, or may be data obtained by postprocessing the output information of the second model.

In some embodiments of the disclosure, the operation S320 includes that: in a case that a size of a predictive spatial filter set configured by the network device is different from a size of a predictive spatial filter set supported by the second model, output information of the second model is processed to obtain the target information. The output information includes information of Q predictive spatial filters.

For example, in a case that the size of the predictive spatial filter set configured by the network device is smaller than the size of the predictive spatial filter set supported by the second model, the information of the Q target spatial filters is determined according to the information of the Q predictive spatial filters and a first mapping relationship. The first mapping relationship is a mapping relationship between spatial filters in the predictive spatial filter set configured by the network device and spatial filters in the predictive spatial filter set supported by the second model.

For another example, in a case that the size of the predictive spatial filter set configured by the network device is greater than the size of the predictive spatial filter set supported by the second model, information of Y predictive spatial filters is determined according to the information of the Q predictive spatial filters and a second mapping relationship. The second mapping relationship is a mapping relationship between spatial filters in the predictive spatial filter set configured by the network device and spatial filters in the predictive spatial filter set supported by the second model, Y being greater than Q.

The information of the Q target spatial filters is determined from the information of Y predictive spatial filters.

For example, Q pieces of information are randomly selected from the information of the Y predictive spatial filters as the information of Q target spatial filters.

Optionally, in some embodiments of the disclosure, after predicting the Q target spatial filters, the network device may also perform secondary beam sweeping to determine the performance of the predicted Q target spatial filters.

For example, the network device may trigger a beam sweeping procedure including the Q target spatial filters, and the terminal device measures the Q target spatial filters and further feeds back measurement results of the Q target spatial filters to the network device.

Optionally, the network device may select a spatial filter according to the measurement results of the Q target spatial filters obtained by the secondary sweeping. The spatial filter selected by the network device is further indicated by third indication information.

That is to say, the spatial filter indicated by the third indication information may be predicted by the network device based on the second model, or may be selected by the network device according to measurement results of the secondary sweeping.

In some embodiments of the disclosure, the method 300 further includes that: the network device sends third indication information to the terminal device. The third indication information indicates at least one target spatial filter among the Q target spatial filters or at least one target transmitting spatial filter corresponding to the at least one target spatial filter.

Situation 1: the Q target spatial filters are Q spatial filter pairs.

In some embodiments, the third indication information indicates one or more spatial filter pairs among the Q spatial filter pairs.

In some other embodiments, the third indication information indicates a transmitting spatial filter(s) of a target spatial filter pair(s), and the target spatial filter pair(s) include(s) one or more spatial filter pairs among the Q spatial filter pairs.

Optionally, the third indication information indicates at least one transmission configuration indication (TCI) state, and the at least one TCI state corresponds to the transmitting spatial filter(s) of the target spatial filter pair(s).

For example, the Q target spatial filters are Q beam pairs, and the third indication information indicates L beam pairs among the K beam pairs or indicates L transmitting beams of the L beam pairs. L is a positive integer.

Optionally, the third indication information indicates L TCI states. The L TCI states correspond to L transmitting beams.

Optionally, in a case that the network device configures the set A for the terminal device, the network device may indicate a target beam pair among the Q beam pairs. In this way, the terminal device may determine a corresponding receiving beam according to the set A.

Optionally, in a case that the network device does not configure set A for the terminal device, the network device may indicate a transmitting beam of the target beam pair, and further trigger a secondary sweeping procedure to enable the terminal device to find a suitable receiving beam.

Situation 2: the Q target spatial filters include Q transmitting spatial filters.

In this situation, the third indication information indicates one or more transmitting spatial filters among the Q transmitting spatial filters.

For example, the Q target spatial filters are Q transmitting beams, and the third indication information indicates L transmitting beams among the Q transmitting beams. L is a positive integer.

Optionally, the third indication information indicates L TCI states. The L TCI states correspond to L transmitting beams.

Situation 3: the Q target spatial filters include Q receiving spatial filters.

In this situation, the third indication information indicates one or more receiving spatial filters among the Q receiving spatial filters.

For example, the Q target spatial filters are Q receiving beams, and the third indication information indicates L receiving beams among the Q receiving beams. L is a positive integer.

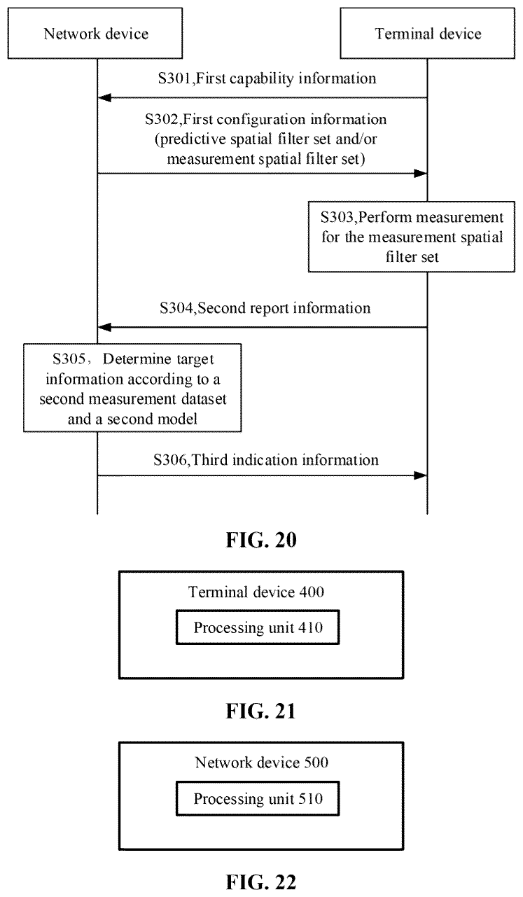

Hereinafter, a specific implementation process in which the network device performs spatial filter prediction when a model for spatial filter prediction is deployed at the network device side is be described in conjunction with FIG. 20. As illustrated in FIG. 20, the implementation process may include at least some of following operations S301 to S306.

At S301, the terminal device sends first capability information to a network device.

The specific implementation of the first capability information may refer to relevant description of the method 200, which will not be described here again.

At S302, the network device sends first configuration information to the terminal device.

The first configuration information is configured to configure a predictive spatial filter set and/or a measurement spatial filter set.

In some embodiments, the first configuration information may be configured to configure a predictive spatial filter set and a measurement spatial filter set.

In some other embodiments, the first configuration information indicates multiple predictive spatial filter sets and multiple measurement spatial filter sets, or indicates multiple predictive spatial filter sets and one measurement spatial filter set, or indicates one predictive spatial filter set and multiple measurement spatial filter sets.

Optionally, when the network device configures multiple predictive spatial filter sets and/or multiple measurement spatial filter sets for the terminal device, the network device may indicate a target predictive spatial filter set among the multiple predictive spatial filter sets and/or a target measurement spatial filter set among the multiple measurement spatial filter sets.

Specific implementation may refer to relevant description of the first indication information previously, which will not be described here again for simplicity.

At S303, the terminal device performs measurement based on a measurement spatial filter set.

At S304, the terminal device sends second report information to the network device.

The second report information is used for reporting measurement results of spatial filters in the measurement spatial filter set. Specific implementation may refer to relevant description of the second report information previously, which will not be described here again for simplicity.

At S305, target information is determined according to the second dataset and a second model.

Optionally, in S305, the network device may further preprocess the second dataset.

The specific implementation may refer to relevant description of previous embodiments, which will not be described here again.

Optionally, in S305, the network device may further postprocess output information of the second model. The specific implementation may refer to relevant description of previous embodiments, which will not be described here again.

At S306, the network device sends third indication information to the terminal device. The third indication information indicates a spatial filter selected by the network device.

The specific implementation of the third indication information may refer to relevant description of previous embodiments, which will not be described here again.

Hereinafter, specific implementations of three prediction scenarios are described in conjunction with embodiments 4 to 6.

Embodiment 4: spatial filter pair prediction, or beam pair prediction. The purpose of beam pair prediction is the same as that of the P1 procedure, namely to find a suitable beam pair in the process that both the terminal device and the network device perform beam sweeping.

Specifically, at least some of following operations 1 to 6 may be included.

At operation 1, the terminal device sends first capability information to the network device.

Optionally, the first capability information indicates beam or beam pair related information supported by the terminal device, or beam or beam pair related information associated with the first model. Relevant description of previous embodiments may be referred to for specific implementation.

As an example, the first capability information indicates a predictive beam pair set and a measurement beam pair set.

At operation 2, the network device sends first configuration information to the terminal device.

The first configuration information is configured to configure a predictive beam pair set and a measurement beam pair set.

In some embodiments, the first configuration information may be configured to configure a combination of a predictive beam pair set and a measurement beam pair set.

In some other embodiments, the first configuration information indicates multiple combinations, each combination being a combination of a respective predictive beam set and a respective measurement beam set.

Optionally, when the network device configures multiple combinations for the terminal device, each combination being a combination of a respective predictive beam set and a respective measurement beam set, the network device may indicate a target combination of the multiple combinations.

At operation 3, the terminal device performs measurement based on the measurement beam pair set.

At operation 4, the terminal device sends second report information to the network device. Specific implementation may refer to relevant description of the second report information previously, which will not be described here again for simplicity.

Optionally, the second report information may include measurement results of all beam pairs in the measurement beam pair set.

Optionally, the second report information may include identification information of all beam pairs in the measurement beam pair set and measurement results of all beam pairs in the measurement beam pair set.

At operation 5, target information is determined according to the second dataset and a second model.

The second dataset is obtained from the second report information.

Optionally, in operation 5, when the number of dimensions of the second dataset is different from the number of input dimensions supported by the second model, the network device may further preprocess the second dataset. The specific implementation may refer to relevant description of previous embodiments, which will not be described here again.

Optionally, in operation 5, when the number of dimensions of the predictive beam pair set configured by the network device is different from the number of dimensions of the predictive beam pair set supported by the second model, the network device may further postprocess output information of the second model. The specific implementation may refer to relevant description of previous embodiments, which will not be described here again.

At operation 6, the network device sends third indication information to the terminal device. The third indication information indicates a beam pair or transmitting beam selected by the network device.

For example, the third indication information may indicate one or more beam pairs among the Q beam pairs, for example indicating identification information of the one or more beam pairs.

For another example, the third indication information may indicate a transmitting beam of a target beam pair among the Q beam pairs, for example indicating identification information of the transmitting beam of the target beam pair.

Optionally, the network device may indicate a transmitting beam by a TCI state.

Embodiment 5: transmitting spatial filter prediction, or transmitting beam prediction. The purpose of transmitting beam prediction is the same as that of the P2 procedure, namely to find a suitable transmitting beam during transmitting beam sweeping. During beam sweeping, a network device sweeps transmitting beams, and a terminal device uses a fixed receiving beam.

Specifically, at least some of following operations 1 to 6 may be included.

At operation 1, the terminal device sends first capability information to the network device.

Optionally, the first capability information indicates beam or beam pair related information supported by the terminal device, or beam or beam pair related information associated with the first model. Relevant description of previous embodiments may be referred to for specific implementation.

As an example, the first capability information indicates a predictive transmitting beam set and a measurement transmitting beam set.

At operation 2, the network device sends first configuration information to the terminal device.

The first configuration information is configured to configure a predictive transmitting beam set and a measurement transmitting beam set.

In some embodiments, the first configuration information may be configured to configure a combination of a predictive transmitting beam set and a measurement transmitting beam set.

In some other embodiments, the first configuration information indicates multiple combinations, each combination being a combination of a respective predictive transmitting beam set and a respective measurement transmitting beam set.

Optionally, when the network device configures multiple combinations for the terminal device, each combination being a combination of a respective predictive transmitting beam set and a respective measurement transmitting beam set, the network device may indicate a target combination of the multiple combinations.

At operation 3, the terminal device performs measurement based on the measurement transmitting beam set.

At operation 4, the terminal device sends second report information to the network device. Specific implementation may refer to relevant description of the second report information previously, which will not be described here again for simplicity.

Optionally, the second report information may include measurement results of all transmitting beams in the measurement transmitting beam set.

Optionally, the second report information may include identification information of all transmitting beams in the measurement transmitting beam set and measurement results of all transmitting beams in the measurement transmitting beam set.

At operation 5, target information is determined according to the second dataset and a second model.

The second dataset is obtained from the second report information.

Optionally, in operation 5, when the number of dimensions of the second dataset is different from the number of input dimensions supported by the second model, the network device may further preprocess the second dataset. The specific implementation may refer to relevant description of previous embodiments, which will not be described here again.

Optionally, in operation 5, when the number of dimensions of the predictive transmitting beam set configured by the network device is different from the number of dimensions of the predictive transmitting beam set supported by the second model, the network device may further postprocess output information of the second model. The specific implementation may refer to relevant description of previous embodiments, which will not be described here again.

Operation 6, the network device sends third indication information to the terminal device. The third indication information indicates a transmitting beam selected by the network device.

For example, the third indication information may indicate a target transmitting beam among the Q transmitting beams.

Optionally, the network device may indicate a transmitting beam by a TCI state.

Embodiment 6: receiving spatial filter prediction, or receiving beam prediction. The purpose of receiving beam prediction is the same as that of the P3 procedure, namely to find a suitable receiving beam during receiving beam sweeping. During the P3 beam sweeping, a network device uses a fixed transmitting beam, and a terminal device sweeps receiving beams.

Specifically, at least some of following operations 1 to 6 may be included.

At operation 1, the terminal device sends first capability information to the network device.

Optionally, the first capability information indicates beam or beam pair related information supported by the terminal device, or beam or beam pair related information associated with the first model. Relevant description of previous embodiments may be referred to for specific implementation.

As an example, the first capability information indicates a predictive receiving beam set and a measurement receiving beam set.

At operation 2, the network device sends first configuration information to the terminal device.

The first configuration information is configured to configure a predictive receiving beam set and a measurement receiving beam set.

In some embodiments, the first configuration information may be configured to configure a combination of a predictive receiving beam set and a measurement receiving beam set.

In some other embodiments, the first configuration information indicates multiple combinations, each combination being a combination of a respective predictive receiving beam set and a respective measurement receiving beam set.

Optionally, when the network device configures multiple combinations for the terminal device, each combination being a combination of a respective predictive receiving beam set and a respective measurement receiving beam set, the network device may indicate a target combination of the multiple combinations.

At operation 3, the terminal device performs measurement based on the measurement receiving beam set.

At operation 4, the terminal device sends second report information to the network device. Specific implementation may refer to relevant description of the second report information previously, which will not be described here again for simplicity.

Optionally, the second report information may include measurement results of all receiving beams in the measurement receiving beam set.

Optionally, the second report information may include identification information of all receiving beams in the measurement receiving beam set and measurement results of all receiving beams in the measurement receiving beam set.

At operation 5, target information is determined according to the second dataset and a second model.

The second dataset is obtained from the second report information.

Optionally, in operation 5, when the number of dimensions of the second dataset is different from the number of input dimensions supported by the second model, the network device may further preprocess the second dataset. The specific implementation may refer to relevant description of previous embodiments, which will not be described here again.

Optionally, in operation 5, when the number of dimensions of the predictive receiving beam set configured by the network device is different from the number of dimensions of the predictive receiving beam set supported by the second model, the network device may further postprocess output information of the second model. The specific implementation may refer to relevant description of previous embodiments, which will not be described here again.

At operation 6, the network device sends third indication information to the terminal device. The third indication information indicates a receiving beam selected by the network device.

For example, the third indication information may indicate a target receiving beam among the Q receiving beams.

In summary, in the embodiments of the disclosure, the network device may predict a target spatial filter(s) based on a model, so that the network device and the terminal device do not need to sweep all spatial filters in a predictive spatial filter set, which is beneficial to reducing sweeping overhead and delay.

In some scenarios, the terminal device may send first capability information to the network device, for reporting beam-related capability information of the terminal device.

In some embodiments, the network device may send first configuration information to the terminal device. The first configuration information is configured to configure a predictive spatial filter set and/or a measurement spatial filter set.

In some embodiments, the terminal device may perform measurement based on a measurement spatial filter set, to obtain a dataset for prediction.

Further, the terminal device may send second report information to the network device. The second report information is used for reporting measurement results of spatial filters in the measurement spatial filter set.

In some embodiments, the network device may predict information of a target spatial filter predicted based on a model and a dataset.

Further, the network device may indicate a selected spatial filter device or an actually used spatial filter to the terminal device.

The method embodiments of the disclosure have been described in detail above in conjunction with FIG. 9 to FIG. 20. The device embodiments of the disclosure are described in detail in conjunction with FIG. 21 to FIG. 27 hereinafter. It is to be understood that the device embodiments and the method embodiments correspond to each other, and reference may be made to the method embodiments for similar descriptions.

FIG. 21 illustrates a schematic block diagram of a terminal device 400 according to embodiments of the disclosure. As illustrated in FIG. 21, the terminal device 400 further includes a processing unit 410.

The processing unit 410 is configured to: acquire a first dataset. The first dataset includes information of multiple measurement spatial filters. The multiple measurement spatial filters belong to a measurement spatial filter set. The measurement spatial filter set is a spatial filter set for measurement.

The processing unit 410 is configured to: determine target information according to the first dataset and a first model. The target information includes information of K target spatial filters. The K target spatial filters belong to a predictive spatial filter set. The predictive spatial filter set is a spatial filter set for prediction. The measurement spatial filter set is a subset of the predictive spatial filter set. K is a positive integer.

In some embodiments, the multiple measurement spatial filters are one or more spatial filter pairs, and each spatial filter pair includes a transmitting spatial filter and a receiving spatial filter; or the multiple measurement spatial filters are transmitting spatial filters; or the multiple measurement spatial filters are receiving spatial filters.

In some embodiments, the information of the multiple measurement spatial filters includes identification information of the multiple measurement spatial filters and/or measurement results of the multiple measurement spatial filters.

In some embodiments, the target spatial filters are one or more spatial filter pairs, and each spatial filter pair includes a transmitting spatial filter and a receiving spatial filter; or the target spatial filters are transmitting spatial filters; or the target spatial filters are receiving spatial filters.

In some embodiments, the information of the target spatial filters includes identification information of the target spatial filters and/or measurement results of the target spatial filters.

In some embodiments, the terminal device further includes a communication unit, configured to send first capability information to a network device. The first capability information indicates a spatial filter capability supported by the terminal device.

In some embodiments, the first capability information indicates at least one of: a number of transmitting spatial filters supported by the terminal device; and a number of receiving spatial filters supported by the terminal device.

In some embodiments, the terminal device further includes a communication unit, configured to receive first configuration information from a network device. The first configuration information is configured to configure at least one predictive spatial filter set and/or at least one measurement spatial filter set.

In some embodiments, the first configuration information is carried in a radio resource control (RRC) signaling.

In some embodiments, the at least one predictive spatial filter set includes multiple predictive spatial filter sets and/or the at least one measurement spatial filter set includes multiple measurement spatial filter sets. The terminal device further includes a communication unit. The communication unit is configured to receive first indication information from the network device.

The first indication information indicates a target predictive spatial filter set among the multiple predictive spatial filter sets and/or a target measurement spatial filter set among the multiple measurement spatial filter sets.

In some embodiments, the first indication information is carried in at least one of following signaling: a radio resource control (RRC) signaling, a media access control control element (MAC CE), and downlink control information (DCI).

In some embodiments, the processing unit 410 is further configured to: in a case that a number of pieces of the information of the multiple measurement spatial filters included in the first dataset is different from a number of pieces of input information of spatial filters supported by the first model, process the information of the multiple measurement spatial filters to obtain target input information. A number of pieces of information of measurement spatial filters included in the target input information is the same as the number of pieces of the input information of the spatial filters supported by the first model. The processing unit 410 is further configured to process, through the first model, the target input information, to obtain the target information.

In some embodiments, the processing unit 410 is further configured to: in a case that the number of pieces of the information of the multiple measurement spatial filters included in the first dataset is smaller than the number of pieces of the input information of the spatial filters supported by the first model, upsample the information of the multiple measurement spatial filters to obtain the target input information; or in a case that the number of pieces of the information of the multiple measurement spatial filters included in the first dataset is greater than the number of pieces of the input information of the spatial filters supported by the first model, downsample the information of the multiple measurement spatial filters to obtain the target input information.

In some embodiments, the processing unit 410 is further configured to: in a case that a size of a predictive spatial filter set configured by a network device is different from a size of a predictive spatial filter set supported by the first model, process output information of the first model to obtain the target information. The output information includes information of K predictive spatial filters.

In some embodiments, the processing unit 410 is further configured to: in a case that the size of the predictive spatial filter set configured by the network device is smaller than the size of the predictive spatial filter set supported by the first model, determine the information of the K target spatial filters according to the information of the K predictive spatial filters and a first mapping relationship. The first mapping relationship is a mapping relationship between spatial filters in the predictive spatial filter set configured by the network device and spatial filters in the predictive spatial filter set supported by the first model.

In some embodiments, the processing unit 410 is further configured to: in a case that the size of the predictive spatial filter set configured by the network device is greater than the size of the predictive spatial filter set supported by the first model, determine information of X predictive spatial filters according to the information of the K predictive spatial filters and a second mapping relationship. The second mapping relationship is a mapping relationship between spatial filters in the predictive spatial filter set configured by the network device and spatial filters in the predictive spatial filter set supported by the first model, X being greater than K. The processing unit 410 is further configured to determine the information of the K target spatial filters from the information of X predictive spatial filters.

In some embodiments, the terminal device further includes a communication unit.

The communication unit is configured to send first report information to a network device. The first report information indicates the information of the K target spatial filters or information of K transmitting spatial filters corresponding to the K target spatial filters.

In some embodiments, in a case that the K target spatial filters are K spatial filter pairs, the first report information indicates information of the K spatial filter pairs or information of transmitting spatial filters of the K spatial filter pairs.

In some embodiments, the first report information includes identification information of the K target spatial filters and measurement results of the K target spatial filters; or the first report information includes identification information of the K transmitting spatial filters and the measurement results of the K target spatial filters.

In some embodiments, in the first report information, the K target spatial filters are arranged in a descending order of the measurement results of the K target spatial filters.

In some embodiments, in a case that the K target spatial filters are K transmitting spatial filters, the first report information includes identification information of the K transmitting spatial filters and measurement results of the K transmitting spatial filters.

In some embodiments, in the first report information, the K transmitting spatial filters are arranged in a descending order of the measurement results of the K transmitting spatial filters.

In some embodiments, the terminal device further includes a communication unit.

The communication unit is configured to receive second indication information from the network device. The second indication information indicates at least one target spatial filter among the K target spatial filters or at least one transmitting spatial filter corresponding to the at least one target spatial filter.

In some embodiments, in a case that the first report information includes information of K spatial filter pairs, the second indication information indicates a target spatial filter pair(s) among the K spatial filter pairs, or the second indication information indicates a transmitting spatial filter of the target spatial filter pair(s). The target spatial filter pair(s) include(s) one or more spatial filter pairs among the K spatial filter pairs.

In some embodiments, in a case that the first report information includes information of K transmitting spatial filters, the second indication information indicates at least one transmitting spatial filter among the K transmitting spatial filters.

In some embodiments, the second indication information indicates at least one transmission configuration indication (TCI) state, and the at least one TCI state corresponds to the at least one transmitting spatial filter.

Optionally, in some embodiments, the communication unit may be a communication interface or a transceiver, or an input/output interface of a communication chip or a system on chip. The above processing unit may be one or more processors.

It is to be understood that the terminal device 400 according to the embodiments of the disclosure may correspond to the terminal device in the method embodiments of the disclosure, and the above and other operations and/or functions of various units in the terminal device 400 are intended to realize the corresponding procedures of the terminal device in the method 200 of in FIG. 9 to FIG. 18 respectively, which are not described herein again for simplicity.

FIG. 22 illustrates a schematic block diagram of a network device according to embodiments of the disclosure. The network device 500 of FIG. 22 includes a processing unit 410.

The processing unit 510 is configured to acquire a second dataset. The second dataset includes information of multiple measurement spatial filters, and the multiple measurement spatial filters belong to a measurement spatial filter set. The processing unit 510 is configured to determine target information according to the second dataset and a second model. The target information includes information of Q target spatial filters. The Q target spatial filters belong to a predictive spatial filter set. The measurement spatial filter set is a subset of the predictive spatial filter set. Q is a positive integer.

In some embodiments, the multiple measurement spatial filters are one or more spatial filter pairs, and each spatial filter pair includes a transmitting spatial filter and a receiving spatial filter; or the multiple measurement spatial filters are transmitting spatial filters; or the multiple measurement spatial filters are receiving spatial filters.

In some embodiments, the information of the multiple measurement spatial filters includes identification information of the multiple measurement spatial filters and/or measurement results of the multiple measurement spatial filters.

In some embodiments, the target spatial filters are one or more spatial filter pairs, and each spatial filter pair includes a transmitting spatial filter and a receiving spatial filter; or the target spatial filters are transmitting spatial filters; or the target spatial filters are receiving spatial filters.

In some embodiments, the information of the target spatial filters includes identification information of the target spatial filters and/or measurement results of the target spatial filters.

In some embodiments, the network device further includes a communication unit.

The communication unit is configured to receive first capability information from a terminal device. The first capability information indicates a spatial filter capability supported by the terminal device.

In some embodiments, the first capability information indicates at least one of: a number of transmitting spatial filters supported by the terminal device; and a number of receiving spatial filters supported by the terminal device.

In some embodiments, the network device further includes a communication unit. The communication unit is configured to send first configuration information to a terminal device. The first configuration information is configured to configure at least one predictive spatial filter set and/or at least one measurement spatial filter set.

In some embodiments, the first configuration information is carried in a radio resource control (RRC) signaling.

In some embodiments, the at least one predictive spatial filter set includes multiple predictive spatial filter sets and/or the at least one measurement spatial filter set includes multiple measurement spatial filter sets. The network device further includes a communication unit. The communication unit is configured to send first indication information to the terminal device. The first indication information indicates a target predictive spatial filter set among the multiple predictive spatial filter sets and/or a target measurement spatial filter set among the multiple measurement spatial filter sets.

In some embodiments, the first indication information is carried in at least one of following signaling: a radio resource control (RRC) signaling, a media access control control element (MAC CE), and downlink control information (DCI).

In some embodiments, the network device further includes a communication unit. The communication unit is configured to receive second report information from a terminal device. The second report information indicates measurement results of measurement spatial filters in the measurement spatial filter set.

In some embodiments, the second report information includes measurement results of all measurement spatial filters in the measurement spatial filter set; or the second report information includes identification information of all the measurement spatial filters in the measurement spatial filter set and the measurement results of all the measurement spatial filters in the measurement spatial filter set.

In some embodiments, the second report information includes the measurement results of all the measurement spatial filters in the measurement spatial filter set, and in the second report information, the measurement results of all the measurement spatial filters in the measurement spatial filter set are arranged according to the identification information of all the measurement spatial filters.

In some embodiments, the second report information includes the identification information of all the measurement spatial filters in the measurement spatial filter set and the measurement results of all the measurement spatial filters in the measurement spatial filter set, and in the second report information, the measurement results of the measurement spatial filters in the measurement spatial filter set are arranged in a descending order.

In some embodiments, the processing unit 510 is further configured to: in a case that a number of pieces of the information of the multiple measurement spatial filters included in the second dataset is different from a number of input dimensions of the second model, process the information of the multiple measurement spatial filters to obtain target input information. A number of pieces of information of measurement spatial filters included in the target input information is the same as the number of input dimensions of the second model. The processing unit 510 is further configured to processing, through the second model, the target input information, to obtain the target information.

In some embodiments, the processing unit 510 is further configured to: in a case that the number of pieces of the information of the multiple measurement spatial filters included in the second dataset is smaller than the number of input dimensions of the second model, upsample the information of the multiple measurement spatial filters to obtain the target input information; or in a case that the number of pieces of the information of the multiple measurement spatial filters included in the second dataset is greater than the number of input dimensions of the second model, downsample the information of the multiple measurement spatial filters to obtain the target input information.

In some embodiments, the processing unit 510 is further configured to: in a case that a size of a predictive spatial filter set configured by the network device is different from a size of a predictive spatial filter set supported by the second model, process output information of the second model to obtain the target information. The output information includes information of Q predictive spatial filters.

In some embodiments, the processing unit 510 is further configured to: in a case that the size of the predictive spatial filter set configured by the network device is smaller than the size of the predictive spatial filter set supported by the second model, determine the information of the Q target spatial filters according to the information of the Q predictive spatial filters and a first mapping relationship. The first mapping relationship is a mapping relationship between spatial filters in the predictive spatial filter set configured by the network device and spatial filters in the predictive spatial filter set supported by the second model.

In some embodiments, the processing unit 510 is further configured to: in a case that the size of the predictive spatial filter set configured by the network device is greater than the size of the predictive spatial filter set supported by the second model, determine information of Y predictive spatial filters according to the information of the Q predictive spatial filters and a second mapping relationship. The second mapping relationship is a mapping relationship between spatial filters in the predictive spatial filter set configured by the network device and spatial filters in the predictive spatial filter set supported by the second model, Y being greater than Q. The processing unit 510 is further configured to determine the information of the Q target spatial filters from the information of Y predictive spatial filters.

In some embodiments, the network device further includes a communication unit. The communication unit is configured to send third indication information to the terminal device. The third indication information indicates at least one target spatial filter among the Q target spatial filters or at least one target transmitting spatial filter corresponding to the at least one target spatial filter.

In some embodiments, the Q target spatial filters include Q spatial filter pairs, and the third indication information indicates one or more spatial filter pairs among the Q spatial filter pairs; or the Q target spatial filters include Q spatial filter pairs, the third indication information indicates a transmitting spatial filter(s) of a target spatial filter pair(s), and the target spatial filter pair(s) include(s) one or more spatial filter pairs among the Q spatial filter pairs.

In some embodiments, the third indication information indicates at least one transmission configuration indication (TCI) state, and the at least one TCI state corresponds to the transmitting spatial filter of the target spatial filter pair.

In some embodiments, the Q target spatial filters include Q transmitting spatial filters, and the third indication information indicates one or more transmitting spatial filters among the Q transmitting spatial filters.

In some embodiments, the Q target spatial filters include Q receiving spatial filters, and the third indication information indicates one or more receiving spatial filters among the Q receiving spatial filters.

Optionally, in some embodiments, the communication unit may be a communication interface or a transceiver, or an input/output interface of a communication chip or a system on chip. The above processing unit may be one or more processors.

It is to be understood that the network device 500 according to the embodiments of the disclosure may correspond to the network device in the method embodiments of the disclosure, and the above and other operations and/or functions of various units in the network device 500 are intended to realize the corresponding procedures of the network device in the method 300 of in FIG. 19 and FIG. 20 respectively, which are not described herein again for simplicity.

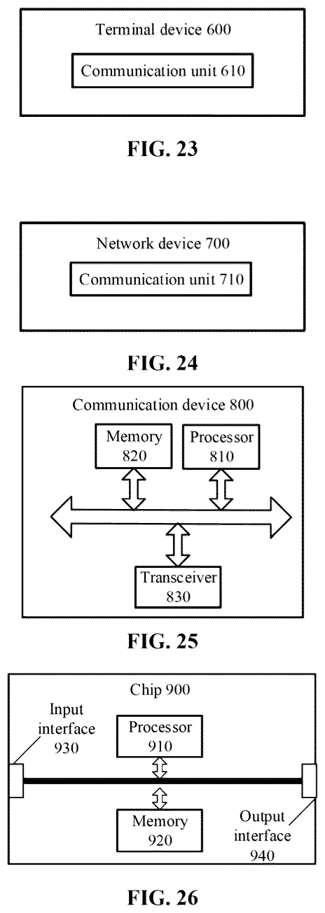

FIG. 23 illustrates a schematic block diagram of a terminal device 600 according to embodiments of the disclosure. As illustrated in FIG. 23, the terminal device 600 includes a communication unit 610.

The communication unit 610 is configured to send a second dataset to a network device. The second dataset is used for the network device to determine target information. The second dataset includes information of multiple measurement spatial filters. The multiple measurement spatial filters belong to a measurement spatial filter set. The target information includes information of Q target spatial filters. The Q target spatial filters belong to a predictive spatial filter set. The measurement spatial filter set is a subset of the predictive spatial filter set. Q is a positive integer.

In some embodiments, the multiple measurement spatial filters are one or more spatial filter pairs, and each spatial filter pair includes a transmitting spatial filter and a receiving spatial filter; or the multiple measurement spatial filters are transmitting spatial filters; or the multiple measurement spatial filters are receiving spatial filters.

In some embodiments, the information of the multiple measurement spatial filters includes identification information of the multiple measurement spatial filters and/or measurement results of the multiple measurement spatial filters.

In some embodiments, the target spatial filters are one or more spatial filter pairs, and each spatial filter pair includes a transmitting spatial filter and a receiving spatial filter; or the target spatial filters are transmitting spatial filters; or the target spatial filters are receiving spatial filters.

In some embodiments, the information of the target spatial filters includes identification information of the target spatial filters and/or measurement results of the target spatial filters.

In some embodiments, the terminal device further includes a communication unit. The communication unit is configured to send first capability information to the network device. The first capability information indicates a spatial filter capability supported by the terminal device.

In some embodiments, the first capability information indicates at least one of: a number of transmitting spatial filters supported by the terminal device; and a number of receiving spatial filters supported by the terminal device.

In some embodiments, the terminal device further includes a communication unit. The communication unit is configured to receive first configuration information from the network device. The first configuration information is configured to configure at least one predictive spatial filter set and/or at least one measurement spatial filter set.

In some embodiments, the first configuration information is carried in a radio resource control (RRC) signaling.

In some embodiments, the at least one predictive spatial filter set includes multiple predictive spatial filter sets and/or the at least one measurement spatial filter set includes multiple measurement spatial filter sets.

The method further includes that the terminal device receives first indication information from the network device. The first indication information indicates a target predictive spatial filter set among the multiple predictive spatial filter sets and/or a target measurement spatial filter set among the multiple measurement spatial filter sets.

In some embodiments, the first indication information is carried in at least one of following signaling: a radio resource control (RRC) signaling, a media access control control element (MAC CE), and downlink control information (DCI).

In some embodiments, the terminal device further includes a communication unit. The communication unit is configured to send second report information to the network device. The second report information indicates measurement results of measurement spatial filters in the measurement spatial filter set.

In some embodiments, the second report information includes measurement results of all measurement spatial filters in the measurement spatial filter set; or the second report information includes identification information of all the measurement spatial filters in the measurement spatial filter set and the measurement results of all the measurement spatial filters in the measurement spatial filter set.

In some embodiments, the second report information includes the measurement results of all the measurement spatial filters in the measurement spatial filter set, and in the second report information, the measurement results of all the measurement spatial filters in the measurement spatial filter set are arranged according to the identification information of all the measurement spatial filters.

In some embodiments, the second report information includes the identification information of all the measurement spatial filters in the measurement spatial filter set and the measurement results of all the measurement spatial filters in the measurement spatial filter set, and in the second report information, the measurement results of the measurement spatial filters in the measurement spatial filter set are arranged in a descending order.

In some embodiments, the terminal device further includes a communication unit. The communication unit is configured to receive third indication information from the network device. The third indication information indicates at least one target spatial filter among the Q target spatial filters or at least one target transmitting spatial filter corresponding to the at least one target spatial filter.

In some embodiments, the Q target spatial filters include Q spatial filter pairs, and the third indication information indicates one or more spatial filter pairs among the Q spatial filter pairs; or the Q target spatial filters include Q spatial filter pairs, the third indication information indicates a transmitting spatial filter(s) of a target spatial filter pair(s), and the target spatial filter pair(s) include(s) one or more spatial filter pairs among the Q spatial filter pairs.

In some embodiments, the third indication information indicates at least one transmission configuration indication (TCI) state, and the at least one TCI state corresponds to the transmitting spatial filter(s) of the target spatial filter pair(s).

In some embodiments, the Q target spatial filters include Q transmitting spatial filters, and the third indication information indicates one or more transmitting spatial filters among the Q transmitting spatial filters.

In some embodiments, the Q target spatial filters include Q receiving spatial filters, and the third indication information indicates one or more receiving spatial filters among the Q receiving spatial filters.

Optionally, in some embodiments, the communication unit may be a communication interface or a transceiver, or an input/output interface of a communication chip or a system on chip. The above processing unit may be one or more processors.

It is to be understood that the terminal device 600 according to the embodiments of the disclosure may correspond to the terminal device in the method embodiments of the disclosure, and the above and other operations and/or functions of various units in the terminal device 600 are intended to realize the corresponding procedures of the terminal device in the method 300 of in FIG. 19 to FIG. 20 respectively, which are not described herein again for simplicity.

FIG. 24 illustrates a schematic block diagram of a network device according to embodiments of the disclosure. The network device 700 of FIG. 24 includes a communication unit 710.

The communication unit 710 is configured to send first configuration information to a terminal device. The first configuration information is configured to configure at least one predictive spatial filter set and/or at least one measurement spatial filter set. The at least one measurement spatial filter set is used for the terminal device to perform measurement, and each of the at least one measurement spatial filter set is a subset of one of the at least one predictive spatial filter set.

In some embodiments, the at least one measurement spatial filter is at least one spatial filter pair, and each spatial filter pair includes a transmitting spatial filter and a receiving spatial filter; or the at least one measurement spatial filter is at least one transmitting spatial filter; or the at least one measurement spatial filter is at least one receiving spatial filter.

In some embodiments, the one or more target spatial filters are one or more spatial filter pairs, and each spatial filter pair includes a transmitting spatial filter and a receiving spatial filter; or the one or more target spatial filters are one or more transmitting spatial filters; or the one or more target spatial filters are one or more receiving spatial filters.

In some embodiments, the communication unit 710 is further configured to receive first capability information from the terminal device. The first capability information indicates a spatial filter capability supported by the terminal device.

In some embodiments, the first capability information indicates at least one of: a number of transmitting spatial filters supported by the terminal device; and a number of receiving spatial filters supported by the terminal device.

In some embodiments, the at least one predictive spatial filter set and/or the at least one measurement spatial filter set is determined according to the first capability information.

In some embodiments, the at least one predictive spatial filter set includes multiple predictive spatial filter sets and/or the at least one measurement spatial filter set includes multiple measurement spatial filter sets. The communication unit 710 is further configured to send first indication information to the terminal device. The first indication information indicates a target predictive spatial filter set among the multiple predictive spatial filter sets and/or a target measurement spatial filter set among the multiple measurement spatial filter sets.

In some embodiments, the first indication information is carried in at least one of following signaling: a radio resource control (RRC) signaling, a media access control control element (MAC CE), and downlink control information (DCI).

In some embodiments, the communication unit 710 is further configured to receive first report information from the terminal device. The first report information indicates information of K target spatial filters or information of K transmitting spatial filters corresponding to the K target spatial filters, and the K target spatial filters belong to the predictive spatial filter set.

In some embodiments, in a case that the K target spatial filters are K spatial filter pairs, the first report information indicates information of the K spatial filter pairs or information of transmitting spatial filters of the K spatial filter pairs.

In some embodiments, the first report information includes identification information of the K target spatial filters and measurement results of the K target spatial filters; or the first report information includes identification information of the K transmitting spatial filters and the measurement results of the K target spatial filters.

In some embodiments, in the first report information, the K target spatial filters are arranged in a descending order of the measurement results of the K target spatial filters.

In some embodiments, in a case that the K target spatial filters are K transmitting spatial filters, the first report information includes identification information of the K transmitting spatial filters and measurement results of the K transmitting spatial filters.

In some embodiments, in the first report information, the K transmitting spatial filters are arranged in a descending order of the measurement results of the K transmitting spatial filters.

In some embodiments, the communication unit 710 is further configured to send second indication information to the terminal device. The second indication information indicates at least one target spatial filter among the K target spatial filters or at least one transmitting spatial filter corresponding to the at least one target spatial filter.

In some embodiments, in a case that the first report information includes information of K spatial filter pairs, the second indication information indicates a target spatial filter pair(s) among the K spatial filter pairs, or the second indication information indicates a transmitting spatial filter(s) of the target spatial filter pair(s). The target spatial filter pair(s) include(s) one or more spatial filter pairs of the K spatial filter pairs.

In some embodiments, in a case that the first report information includes information of K transmitting spatial filters, the second indication information indicates at least one transmitting spatial filter among the K transmitting spatial filters.

In some embodiments, the second indication information indicates at least one transmission configuration indication (TCI) state, and the at least one TCI state corresponds to the at least one transmitting spatial filter.

In some embodiments, the first configuration information is carried in a radio resource control (RRC) signaling.

Optionally, in some embodiments, the communication unit may be a communication interface or a transceiver, or an input/output interface of a communication chip or a system on chip. The above processing unit may be one or more processors.

It is to be understood that the network device 700 according to the embodiments of the disclosure may correspond to the network device in the method embodiments of the disclosure, and the above and other operations and/or functions of various units in the network device 700 are intended to realize the corresponding procedures of the network device in the method 300 of in FIG. 9 and FIG. 18 respectively, which are not described herein again for simplicity.

FIG. 25 illustrates a schematic structural diagram of a communication device 800 according to embodiments of the disclosure. The communication device 800 as illustrated in FIG. 25 includes a processor 810. The processor 810 may call and run a computer program from a memory to implement the method according to the embodiments of the disclosure.

Optionally, as illustrated in FIG. 8, the communication device 800 may further include a memory 820. The processor 810 may call and run a computer program from the memory 820 to implement the method according to the embodiments of the disclosure.

The memory 820 may be a device independent from the processor 810, or may be integrated in the processor 810.

Optionally, as illustrated in FIG. 8, the communication device 800 may further include a transceiver 830. The processor 810 may control the transceiver 830 to communicate with other devices, in particular to send information or data to other devices or receive information or data from other device.

The transceiver 830 may include a transmitter and a receiver. The transceiver 830 may further include an antenna, and there may be one or more antennas.

Optionally, the communication device 800 may particularly be the network device of the embodiments of the disclosure, and the communication device 800 may implement corresponding procedures that are implemented by the network device in various methods according to the embodiments of the disclosure, which is not described here again for simplicity.

Optionally, the communication device 800 may particularly be a mobile terminal/terminal device according to the embodiments of the disclosure, and the communication device 800 may implement corresponding procedures that are implemented by the mobile terminal/terminal device in various methods according to the embodiments of the disclosure, which is not described here again for simplicity.

FIG. 26 illustrates a schematic structural diagram of a chip according to embodiments of the disclosure. The chip 900 as illustrated in FIG. 26 includes a processor 910. The processor 910 may call and run a computer program from a memory to implement the method according to the embodiments of the disclosure.

Optionally, as illustrated in FIG. 26, the chip 900 may further include a memory 920. The processor 910 may call and run a computer program from the memory 920 to implement the method according to the embodiments of the disclosure.

The memory 920 may be a device independent from the processor 910, or may be integrated in the processor 910.

Optionally, the chip 900 may further include an input interface 930. The processor 910 may control the input interface 930 to communicate with other devices or chips, in particularly to acquire information or data sent by other devices or chips.

Optionally, the chip 900 may further include an output interface 940. The processor 910 may control the output interface 940 to communicate with other devices or chips, in particularly to output information or data to other devices or chips.

Optionally, the chip may be applied to the network device of the embodiments of the disclosure, and the chip may implement corresponding procedures that are implemented by the network device in various methods according to the embodiments of the disclosure, which is not described here again for simplicity.

Optionally, the chip may be applied to a mobile terminal/terminal device according to the embodiments of the disclosure, and the chip may implement corresponding procedures that are implemented by the mobile terminal/terminal device in various methods according to the embodiments of the disclosure, which is not described here again for simplicity.

It should be understood that, the chip mentioned in the embodiments of the disclosure may also be referred to as a system-level chip, a system chip, a chip system or a system-on-chip.

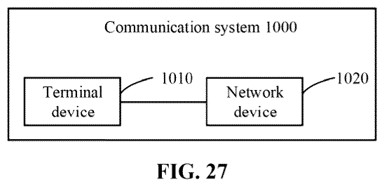

FIG. 27 illustrates a schematic block diagram of a communication system 1000 according to embodiments of the disclosure. As illustrated in FIG. 27, the communication system 1000 includes a terminal device 1010 and a network device 1020.

The terminal device 1010 may be applied to implement corresponding functions implemented by a terminal device in the above methods, and the network device 1020 may be applied to implement corresponding functions implemented by a network device in the above methods, which is not described here again for simplicity.

It should be understood that the processor of the embodiments of the disclosure may be an integrated circuit chip, and has the capability of signal processing. During implementation, the various steps of in the above method embodiment may be completed by an integrated logic circuit in hardware form or instructions in software form in a processor. The above processor may be a general-purpose processor, a digital signal processor (DSP), an application specific integrated circuit (ASIC), a field programmable gate array (FPGA), or another programmable logical device, a discrete gate or a transistor logical device, or a discrete hardware component. The first processor may implement or perform the various methods, steps or logic blocks disclosed in the embodiments of the disclosure. The universal processor may be a microprocessor or the processor may also be any conventional processor and the like. The steps of the methods disclosed in combination with the embodiments of the disclosure may be directly embodied as being performed and completed by a hardware decoding processor, or being performed and completed by a combination of hardware and software modules in a decoding processor. The software module may be located in a mature storage medium in the art such as a random access memory, a flash memory, a read-only memory, a programmable read-only memory, an electrically erasable programmable, or a register. The storage medium is in a memory, and a processor reads information from the memory to implement steps of the above methods in combination with the hardware.

It may be understood that the memory in the embodiments of the disclosure may be a volatile memory or a non-volatile memory, or may include both a volatile memory and a non-volatile memory. The non-volatile memory may be a read-only memory (ROM), a programmable ROM (PROM), an erasable PROM (RPROM), an electrically RPROM (EEPROM), or a flash memory. The volatile memory may be a random access memory (RAM), that is used as an external cache. By way of example, but not limiting description, RAMs in many forms are available, for example, a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a directly rambus RAM (DR RAM). It should be noted that, the memory in the system and method described herein is intended to include but not limited to memories of these and any other suitable types.

It should be understood that the memories are exemplary but not limiting description. For example, the memory in the embodiments of the disclosure may also be a static RAM (SRAM), a dynamic RAM (DRAM), a synchronous DRAM (SDRAM), a double data rate SDRAM (SSD SDRAM), an enhanced SDRAM (ESDRAM), a synch link DRAM (SLDRAM), or a direct Rambus RAM (DR RAM). That is to say, the memory in the embodiments of the disclosure is intended to include but not limited to memories of these and any other suitable types.

Embodiments of the disclosure further provide a computer-readable storage medium for storing a computer program.

Optionally, the computer-readable storage medium may be applied to the network device of the embodiments of the disclosure, and the computer program enables a computer to implement corresponding procedures that are implemented by the network device in various methods according to the embodiments of the disclosure, which is not described here again for simplicity.

Optionally, the computer-readable storage medium may be applied to a mobile terminal/terminal device according to the embodiments of the disclosure, and the computer program enables a computer to implement corresponding procedures that are implemented by the mobile terminal/terminal device in various methods according to the embodiments of the disclosure, which is not described here again for simplicity.

Embodiments of the disclosure further provide a computer program product including computer program instructions.

Optionally, the computer program product may be applied to the network device of the embodiments of the disclosure, and instructions of the computer program product enable a computer to implement corresponding procedures that are implemented by the network device in various methods according to the embodiments of the disclosure, which is not described here again for simplicity.

Optionally, the computer program product may be applied to a mobile terminal/terminal device according to the embodiments of the disclosure, and instructions of the computer program product enable a computer to implement corresponding procedures that are implemented by the mobile terminal/terminal device in various methods according to the embodiments of the disclosure, which is not described here again for simplicity.

Embodiments of the disclosure further provide a computer program.

Optionally, the computer program may be applied to the network device of the embodiments of the disclosure, and the computer program, when running on a computer, enables the computer to implement corresponding procedures that are implemented by the network device in various methods according to the embodiments of the disclosure, which is not described here again for simplicity.

Optionally, the computer program may be applied to a mobile terminal/terminal device according to the embodiments of the disclosure, and the computer program, when running on a computer, enables the computer to implement corresponding procedures that are implemented by the mobile terminal/terminal device in various methods according to the embodiments of the disclosure, which is not described here again for simplicity.

Those of ordinary skill in the art may realize that the units and algorithm steps of various examples described in combination with the embodiments disclosed herein may be implemented by electronic hardware, or a combination of computer software and electronic hardware. Whether the functions are performed in form of hardware or software form depends on the specific application and design constraint conditions of the technical solution. Professionals may use a different method to realize the described function for each specific application, and such implementation should not be construed as extending beyond the scope of the disclosure

Those skilled in the art may clearly appreciate that for convenience and simplicity of description, the particular operation procedures of the system, apparatus and units described above may refer to corresponding procedures in the foregoing method embodiment, which will not be described herein again.

In some embodiments provided in the disclosure, it is to be understood that the disclosed system, device and method may be implemented in other ways. For example, the device embodiment described above is only exemplary, and for example, division of the units is only division in logic functions, and division may be made in other ways during practical implementation. For example, multiple units or components may be combined or integrated into another system, or some features may be neglected or not executed. In addition, coupling or direct coupling or communication connection between various displayed or discussed components may be indirect coupling or communication connection, implemented through some interfaces, devices or units, and may be electrical and mechanical or in other forms.

The units described as separate components may or may not be physically discrete from one another. Components displayed as units may or may not be physical units, and can be located at the same place or may be distributed to multiple network units. Some or all of the units may be chosen to realize the purpose of the solution of the embodiments according to actual requirements.

Additionally, various functional units in the embodiments of the disclosure may be integrated in one processing unit, or may exist separately physically; or two or more units may be integrated in one unit.

If implemented in form of software functional units and sold or used as independent product, the functions may be stored in a computer-readable storage medium. Based on such understanding, the technical solution of the disclosure substantially or in part making contributions to the related art or a part of the technical solution may be embodied in a software product. The computer software product is stored in a storage medium, and includes several instructions to enable a computer device (which may be a personal computer, a server, a network device or the like) to perform all or some steps of the method according to various embodiments of the disclosure. The foregoing storage medium includes various media capable of storage program codes such as a USB flash drive, a mobile hard disk drive, a read-only memory (ROM), a random access memory (RAM), a magnetic disc, or a compact disc (CD).

Stated above is merely detailed description of the disclosure, but the scope of protection of the disclosure is not limited thereto. Any modification or replacement that are easily conceivable by those familiar with the related art within the technical range disclosed by the disclosure shall fall within the scope of protection of the disclosure. Therefore, the scope of protection of the disclosure should be subjected to the claimed scope of the claims.

1. A method for wireless communication, comprising:
acquiring, by a terminal device, a first dataset, wherein the first dataset comprises information of a plurality of measurement spatial filters, the plurality of measurement spatial filters belong to a measurement spatial filter set, and the measurement spatial filter set is a spatial filter set for measurement; and
determining target information according to the first dataset and a first model, wherein the target information comprises information of K target spatial filters, the K target spatial filters belong to a predictive spatial filter set, the predictive spatial filter set is a spatial filter set for prediction, the measurement spatial filter set is a subset of the predictive spatial filter set, and K is a positive integer.

2. The method of claim 1, wherein the information of the plurality of measurement spatial filters comprises identification information of the plurality of measurement spatial filters and/or measurement results of the plurality of measurement spatial filters.

3. The method of claim 1, wherein
the information of the target spatial filters comprises identification information of the target spatial filters and/or measurement results of the target spatial filters.

4. The method of claim 1, further comprising:
sending, by the terminal device, first capability information to a network device, wherein the first capability information indicates a spatial filter capability supported by the terminal device.

5. The method of claim 4, wherein the first capability information indicates at least one of:
a number of transmitting spatial filters supported by the terminal device; and
a number of receiving spatial filters supported by the terminal device.

6. The method of claim 1, further comprising:
receiving, by the terminal device, first configuration information from a network device, wherein the first configuration information is configured to configure at least one predictive spatial filter set and/or at least one measurement spatial filter set.

7. The method of claim 6, wherein the at least one predictive spatial filter set comprises a plurality of predictive spatial filter sets and/or the at least one measurement spatial filter set comprises a plurality of measurement spatial filter sets, and the method further comprises:
receiving, by the terminal device, first indication information from the network device, wherein the first indication information indicates a target predictive spatial filter set among the plurality of predictive spatial filter sets and/or a target measurement spatial filter set among the plurality of measurement spatial filter sets.

8. The method of claim 1, further comprising:
sending, by the terminal device, first report information to a network device, wherein the first report information indicates the information of the K target spatial filters or information of K transmitting spatial filters corresponding to the K target spatial filters.

9. The method of claim 8, wherein in a case that the K target spatial filters are K transmitting spatial filters, the first report information comprises identification information of the K transmitting spatial filters and measurement results of the K transmitting spatial filters.

10. A method for wireless communication, comprising:
acquiring, by a network device, a second dataset, wherein the second dataset comprises information of a plurality of measurement spatial filters, and the plurality of measurement spatial filters belong to a measurement spatial filter set; and
determining target information according to the second dataset and a second model, wherein the target information comprises information of Q target spatial filters, the Q target spatial filters belong to a predictive spatial filter set, the measurement spatial filter set is a subset of the predictive spatial filter set, and Q is a positive integer.

11. The method of claim 10, wherein the information of the plurality of measurement spatial filters comprises identification information of the plurality of measurement spatial filters and/or measurement results of the plurality of measurement spatial filters.

12. The method of claim 10, wherein
the information of the target spatial filters comprises identification information of the target spatial filters and/or measurement results of the target spatial filters.

13. The method of claim 10, further comprising:
receiving, by the network device, first capability information from a terminal device, wherein the first capability information indicates a spatial filter capability supported by the terminal device.

14. The method of claim 13, wherein the first capability information indicates at least one of:
a number of transmitting spatial filters supported by the terminal device; and
a number of receiving spatial filters supported by the terminal device.

15. The method of claim 10, further comprising:
sending, by the network device, first configuration information to a terminal device, wherein the first configuration information is configured to configure at least one predictive spatial filter set and/or at least one measurement spatial filter set.

16. The method of claim 15, wherein the at least one predictive spatial filter set comprises a plurality of predictive spatial filter sets and/or the at least one measurement spatial filter set comprises a plurality of measurement spatial filter sets, and the method further comprises:
sending, by the network device, first indication information to the terminal device, wherein the first indication information indicates a target predictive spatial filter set among the plurality of predictive spatial filter sets and/or a target measurement spatial filter set among the plurality of measurement spatial filter sets.

17. The method of claim 10, wherein acquiring, by the network device, the second dataset comprises:
receiving, by the network device, second report information from a terminal device, wherein the second report information indicates measurement results of measurement spatial filters in the measurement spatial filter set.

18. The method of claim 17, wherein the second report information comprises measurement results of all measurement spatial filters in the measurement spatial filter set; or
the second report information comprises identification information of all the measurement spatial filters in the measurement spatial filter set and the measurement results of all the measurement spatial filters in the measurement spatial filter set.

19. The method of claim 18, wherein the second report information comprises the measurement results of all the measurement spatial filters in the measurement spatial filter set, and in the second report information, the measurement results of the measurement spatial filters are arranged according to the identification information of the measurement spatial filters.

20. The method of claim 17, wherein the second report information comprises the identification information of all the measurement spatial filters in the measurement spatial filter set and the measurement results of all the measurement spatial filters in the measurement spatial filter set, and in the second report information, the measurement results of the measurement spatial filters in the measurement spatial filter set are arranged in a descending order.
